(19) United States
(12) Patent Application Publication
(10) Pub. No.: US 2005/0266184 A1
(43) Pub. Date: Dec. 1, 2005

(54) Image-receiving sheet for electrophotography and image-forming process

(75) Inventors: Masamichi Kobayashi, Shizuoka (JP); Yoshisada Nakamura, Shizuoka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJI PHOTO FILM CO., LTD., Minami-Ashigara-shi (JP)

(21) Appl. No.: 11/130,414

(22) Filed: May 17, 2005

(30) Foreign Application Priority Data
May 18, 2004 (JP) 2004-148299

(51) Int. Cl. G03G 15/20; G03G 13/20

(52) U.S. Cl. 428/32.38; 430/124

(57) ABSTRACT

The object of the present invention is to provide an image-receiving sheet for the electrophotography which is excellent in adhesion resistance and resistance to crazing, and can form an image having a high image quality; and also an image-forming process using the image-receiving sheet for the electrophotography. For this object, the present invention provides an image-receiving sheet for the electrophotography comprising a support and a toner image-receiving layer disposed on the support, wherein the toner image-receiving layer comprises an aqueous polymer dispersion and water-dispersible rosins.

### BACKGROUND OF THE INVENTION

1. Field of the Invention

The present invention relates to an image-receiving sheet for the electrophotography which is excellent in adhesion resistance and resistance to crazing and can obtain an image having a high, and relates also to an image-forming process using the image-receiving sheet for the electrophotography.

2. Description of the Related Art

Conventionally, since the electrophotography method is a dry treatment having an excellent printing rate and the electrophotograph can be out-put on a general-purpose paper, such as a plain paper and a woodfree paper, the electrophotography method is applied to a copy machine or an out-put device of the personal computer. In the image-receiving sheet for the electrophotography, the toner image-receiving layer is disposed according to various methods. For example, a method for laminating a thermoplastic resin on the support, such as a base paper by a melt extrusion or a method for coating the support with a resin liquid is proposed.

Among these methods, since with respect to a method for coating the support with an aqueous polymer dispersion, not only the load against the environment of the earth is small, but also the cost of the material for coating the support with an aqueous polymer dispersion is low, recently, the method for coating the support with an aqueous polymer dispersion has been widely studied. For example, in Japanese Patent Application Laid-Open UP-A) No. 2000-98646, for plasticizing a polyester resin of the toner image-receiving layer, an image-receiving sheet produced using the mixture of the polyester resin with an aliphatic alkyl ester having a molecular weight of 170 to 650 and a melting point of −100° C. to 0° C. With respect to the method disclosed in JP-A No. 2000-98646, while it is effective for enhancing the image quality, it uses a plasticizer having a low meting point, so that a disadvantage is caused wherein the blocking is inevitably impaired.

Further, the JP-A No. 2000-275891 proposes an image receiving medium for the electrophotography which can form a toner reflection image having a high quality by lowering the flow beginning temperature (30° C. or higher) of the toner image-receiving layer through incorporating a plasticizer in the composition of the image-receiving layer. However, in this proposal, there is no specification (e.g., molecular weight or glass transition temperature (Tg)) for the resin used for producing the toner image-receiving layer and since the softening point of the toner image-receiving layer is too low, the high image quality and the blocking can be difficultly compatibilized.

Therefore, it is the present condition that while when, for plasticizing an aqueous dispersion of polymer, a polymer having a low glass transition temperature (Tg) is mixed in a proper mixing ratio with an aqueous polymer dispersion which is a material for producing the toner image-receiving layer, the image quality is improved and the adhesion resistance of the toner image-receiving layer is lowered, when an aqueous polymer dispersion having a low molecular weight (number average molecular weight of less than 30,000) is used as the material for producing the toner image-receiving layer, while there is no problem with respect to the image quality, the adhesion resistance and resistance to crazing of the toner image-receiving layer are largely impaired, so that the adhesion resistance and the high image quality can be extremely difficultly compatibilized.

### SUMMARY OF THE INVENTION

The object of the present invention is to provide an image-receiving sheet for the electrophotography which is excellent in adhesion resistance and resistance to crazing and can obtain an image having a high image quality, wherein the toner image-receiving layer of the image-receiving sheet is produced using an aqueous polymer dispersion having a high molecular weight and water-dispersible rosins having a high softening point as a plasticizer which plasticizes the aqueous polymer dispersion only in the temperature range of the image fixing; and an image-forming process using thereof.

The image-receiving sheet for the electrophotography according to the present invention comprises a support and a toner image-receiving layer disposed on the support, wherein the toner image-receiving layer comprises a mixture of an aqueous polymer dispersion and water-dispersible rosins. The water-dispersible rosins are a plasticizer having a high softening point and by incorporating the water-dispersible rosins in the composition of the toner image-receiving layer, the aqueous polymer dispersion having a high molecular weight is plasticized only in the temperature range of the image fixing, so that an image which is excellent in adhesion resistance and resistance to crazing and has a high quality can be obtained.

The image-forming process according to the present invention comprises forming a toner image in the toner image-receiving sheet for the electrophotography according to the present invention; fixing the toner image formed in the toner image-receiving sheet by heating, pressing and cooling the surface of the toner image using a fixing belt and a fixing roller; and peeling the toner image from the fixing belt. According to the above-noted image-forming process, even if by using an image-forming apparatus equipped with no fixing oil, not only a stable feed of the image-receiving sheet without causing an off-set of the image to the fixing roll or to the fixing belt can be obtained, but also an excellent image having a more excellent glossiness than that of conventional images, which is rich in photographic sense can be obtained.

### BRIEF DESCRIPTION OF THE DRAWING

FIG. 1 is a schematic view showing an example of the image fixing apparatus configured to fix the image by smoothing the surface of the image in the image-forming apparatus according to the present invention.

FIG. 2 is a schematic view showing an example of the image-forming apparatus according to the present invention.

FIG. 3 is a schematic view showing another example of the image fixing apparatus configured to fix the image by smoothing the surface of the image than that shown in FIG. 1.

### DESCRIPTION OF THE PREFERRED EMBODIMENTS

(Image-Receiving Sheet for Electrophotography)

The image-receiving sheet for the electrophotography according to the present invention comprises a support, a toner image-receiving layer disposed on the support and optionally other layers selected properly depending on the application, such as an intermediate layer, a protective layer, an intermediate layer, an undercoating layer, a cushion layer, a charge-controlling (preventing) layer, a reflective layer, a tint-controlling layer, a shelf stability-improving layer, an anti-adhesion layer, an anti-curling layer, a back layer and a smoothing layer. These layers may be in a single layer structure or a laminated structure of plural layers.

[Toner Image-Receiving Layer]

The toner image-receiving layer receives a color toner and a black toner and forms the image. The toner image-receiving layer has a function of receiving the toner for forming the image from a developing drum or an intermediate transfer medium by (static) electricity or pressure during the transferring and a function of fixing the image by heat or pressure during the fixing.

The toner image-receiving layer comprises a mixture of an aqueous polymer dispersion as a binder rein and water-dispersible rosins as a plasticizer, and optionally other components.

—Aqueous Polymer Dispersion—

The aqueous polymer dispersion is not restricted and may be properly selected depending on the application. Examples of the aqueous polymer dispersion include an aqueous dispersion of a water-dispersible polymer, a water-dispersible emulsion and a mixture thereof.

Examples of the polymer in the above-noted aqueous dispersion of a water-dispersible polymer include (1) polyolefin resins, (2) polystyrene resins, (3) acrylic resins, (4) a polyvinyl acetate and a derivative thereof, (5) polyamide resins, (6) a polyester resin, (7) a polycarbonate resin, (8) a polyether resin (or an acetal resin) and (9) other resins; and a mixture thereof.

Examples of the polyolefin resins (1) include a polyolefin resin, such as a polyethylene and a polypropylene; and a copolymer resin produced by copolymerizing an olefin, such as ethylene and propylene with another vinyl monomer. Examples of such a copolymer resin (produced by copolymerizing an olefin with another vinyl monomer) include an ethylene-vinyl acetate copolymer and an ionomer resin which is produced by copolymerizing an olefin with acrylic acid or methacrylic acid. Examples of the derivative of the polyolefin resins include a chlorinated polyethylene and a chlorosulfonated polyethylene.

Examples of the polystyrene resins (2) include a polystyrene resin, a styrene-isobutylene copolymer, an acrylonitrile-styrene copolymer (AS resin), an acrylonitrile-butadiene-styrene copolymer (ABS resin) and a polystyrene-maleic anhydride resin.

Examples of the acrylic resins (3) include a polyacrylic acid and an ester thereof, a polymethacrylic acid and an ester thereof, a polyacrylonitrile and a polyacrylamide.

Examples of the polyacrylic acid ester include a homopolymer and a multiple copolymer of the acrylic acid ester. Examples of the acrylic acid ester include methyl acrylate, ethyl acrylate, n-bytyl acrylate, isobutyl acrylate, dodecyl acrylate, n-octyl acrylate, 2-ethylhexyl acrylate, 2-chloroethyl acrylate, phenyl acrylate and a-chloro methyl acrylate.

Examples of a polyvinyl acetate and a derivative thereof (4) include a polyvinyl acetate, a polyvinyl alcohol produced by saponifying the polyvinyl acetate and a polyvinylacetal produced by reacting the polyvinyl alcohol with an aldehyde (e.g., formaldehyde, acetaldehyde and butyraldehyde).

The polyamide resins (5) are condensation polymers of a diamine and a dibasic acid and examples thereof include 6-nylon and 6,6-nylon.

The polyester resin (6) is a condensation polymers of an acid and an alcohol. The acid is not restricted and may be properly selected depending on the application. Examples of the acid include maleic acid, fumaric acid, citraconic acid, itaconic acid, glutaconic acid, phthalic acid, terephthalic acid, isophthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid, isooctylsuccinic acid, trimellitic acid, a pyromelitic acid and anhydrides of these acids and esters of these acids with lower alkyls.

The alcohol is not restricted and may be properly selected depending on the application. Examples of the fatty diol include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol. Examples of the alkylene oxide adduct of the bisphenol A include polyoxypropylene (2.2)-2,2-bis(4-hydroxyphenyl)propane, polyoxypropylene (3.3)-2,2-bis(4-hydroxyphenyl)propane, polyoxyethylene (2.0)-2,2-bis(4-hydroxyphenyl)propane, polyoxypropylene (2.0)-polyoxyethylene (2.0)-2,2-bis(4-hydroxyphenyl)propane and polyoxypropylene (6)-2,2-bis(4-hydroxyphenyl)propane.

General examples of the polycarbonate resin (7) include a polycarbonate ester produced using bisphenol A and phosgene.

Examples of the polyether resin (or the acetal resin) (8) include a polyether resin, such as a polyethylene oxide and a polypropylene oxide (or an acetal resin produced by a ring opening polymerization, such as a polyoxymethylene).

The other resins (9) include a polyurethane resin produced by an addition polymerization.

The water-dispersible polymer may be a properly synthesized product or a commercially available product. Specific examples of the commercially available water-dispersible polyester polymer include the Vylonal Series (manufactured and sold by Toyobo Co., Ltd), the Pesresin A Series (manufactured and sold by Takamatsu Oil & Fat Co., Ltd.), the Tuftone UE Series (manufactured and sold by Kao Corporation), the WR Series (manufactured and sold by Nippon Synthetic Chemical Industry Co., Ltd.) and the Elitel Series (manufactured and sold by Unitika Ltd). Specific examples of the commercially available water-dispersible acrylic polymer include the Hiros XE, KE and PE series (manufactured and sold by Seiko Chemical Industries Co., Ltd.) and the Jurymer ET series (manufactured and sold by Nihon Junyaku Co., Ltd.).

The water-dispersible emulsion is not restricted so long as the volume average particle diameter thereof is 20 nm or more and may be properly selected depending on the application. Examples of the water-dispersible emulsion include a water-dispersible polyurethane emulsion, a water-dispersible polyester emulsion, an acrylic emulsion, a chloroprene polymer emulsion, a styrene-butadiene copolymer emulsion, a nitrile-butadiene copolymer emulsion, a butadiene polymer emulsion, a vinyl chloride polymer emulsion, a vinylpyridine-styrene-butadiene copolymer emulsion, a polybutene emulsion, a polyethylene emulsion, a vinyl acetate polymer emulsion, an ethylene-vinyl acetate copolymer emulsion, a vinylidene chloride polymer emulsion and a methyl methacrylate-butadiene copolymer emulsion. Among them, the acrylic emulsion and the water-dispersible polyester emulsion are most preferred.

The water-dispersible polyester emulsion is preferably an aqueous self-dispersible polyester emulsion, most preferably an aqueous self-dispersible polyester emulsion containing a carboxyl group. Here, the aqueous self-dispersible polyester emulsion means an aqueous emulsion containing a polyester resin which can be self-dispersed in an aqueous solvent without using an emulsifier. The aqueous self-dispersible polyester emulsion containing a carboxyl group means an aqueous emulsion containing a polyester resin having a carboxyl group as a hydrophilic group, which can be self-dispersed in an aqueous solvent.

The polymer in the aqueous polymer dispersion has a glass transition temperature (Tg) of preferably 30° C. to 90° C., more preferably 40° C. to 70° C. When the glass transition temperature (Tg) is less than 30° C., the adhesion resistance and resistance to the offset of the image-receiving sheet are lowered sometimes. On the other hand, when the glass transition temperature (Tg) is more than 90° C., after the belt fixing of the toner image, the crazing of the image-receiving layer is easily caused some times and the glossiness of the image-receiving sheet is lowered sometimes.

The polymer in the aqueous polymer dispersion has a number average molecular weight (Mn) of preferably 30,000 to 500,000, more preferably 60,000 to 200,000. When the number average molecular weight (Mn) is less than 30,000, after the belt fixing of the toner image, the crazing of the image-receiving layer is easily caused some times. On the other hand, when the number average molecular weight (Mn) is more than 500,000, after the belt fixing of the toner image, the glossiness of the image-receiving sheet is lowered sometimes.

The average particle diameter of the aqueous polymer dispersion is preferably 0.01 μm to 1 μm.

The amount of the aqueous polymer dispersion in the toner image receiving layer is preferably 10 % by mass, more preferably 30 % by mass, still more preferably 50 % by mass, most preferably 50 % by mass to 90 % by mass, based on the mass of the toner image receiving layer.

—Water-Dispersible Rosins—

The water-dispersible rosins are not restricted and may be properly selected depending on the application. Examples of the water-dispersible rosins include a water-dispersible rosin, a water-dispersible rosin derivative and a salt thereof.

Examples of the water-dispersible rosin include a gum rosin, a wood rosin, a tall oil rosin, a disproportioned rosin, a hydrated rosin and a polymerized rosin.

Examples of the water-dispersible rosin derivative include a rosin in which a carboxyl group is remained or introduced, an ester of the rosin and a polyalcohol (a rosin ester), a reaction product (e.g., a rosin-modified maleic acid resin comprising a maleic anhydride adduct of rosin) between the rosin and a poly basic acid (e.g., maleic anhydride), an ester of a maleic anhydride adduct of the rosin and a polyalcohol and a reaction product of a reaction between the rosin and maleic anhydride under the presence of a polyalcohol (e.g., a rosin-modified maleic acid ester resin).

Examples of the polyalcohol include a diol (e.g., an alkylene glycol, such as ethylene glycol, propylene glycol, tetramethylene glycol and hexanediol; polyoxyalkylene glycol; such as diethylene glycol, triethylene glycol, polyethylene glycol, dipropylene glycol, tripropylene glycol and polypropylene glycol); glycerine, pentaerythritol and dipentaerythritol. These polyalcohol may be used individually or in combination. For controlling the acid value of the rosins, the poly alcohol may be used in combination with a monovalent alcohol.

Among these water-dispersible rosins, a rosin derivative, particularly a rosin-modified maleic anhydride resin and a rosin-modified maleic anhydride ster resin which is a reaction product of a reaction between the rosin, maleic anhydride and a polyalcohol are preferred.

Example of the base for forming a salt of the water-dispersible rosins include various organic and inorganic bases. Examples of the organic base include a dialkyl amine, such as dimethyl amine and diethyl amine; a trialkyl amine, such as trimethyl amine and triethyl amine; an alcanol amine, such as dimethyl amino ethanol, diethanol amine and triethanol amine and a heterocyclic amine, such as morphorine, pyridine and pyperidine. Examples of the inorganic base include ammonia; an alkali metal oxide, such as potassium oxide an dsodium oxide; an alkali metal carbonate, such as sodium carbonate; an alkali metal hydrocarbonate, such as sodium hydrogen carbonate. By using the salt of the water-dispersible rosins, the water-dispersibility of the water-dispersible rosins can be enhanced.

The water-dispersible rosins have a softening point of preferably 50° C. to 150° C., more preferably 70° C. to 130° C. When the softening point is less than 50° C., the adhesion resistance and resistance to the offset of the image-receiving sheet is lowered sometimes. On the other hand, when the softening point is more than 150° C., after the belt fixing of the image, the crazing of the image-receiving layer is easily caused sometime and the plasticizing effect of the polymer dispersion is lowered, so that the glossiness of the image-receiving sheet is lowered sometimes.

The water-dispersible rosins have an acid value of preferably 30 mg KOH/g to 400 mg KOH/g, more preferably 40 mg KOH/g to 370 mg KOH/g, still more preferably 50 mg KOH/g to 350 mg KOH/g.

The water-dispersible rosins have a weight average molecular weight of preferably 500 to 10,000, more preferably 700 to 5,000.

The amount of the mixture of the aqueous polymer dispersion and the water-dispersible rosins in the toner image-receiving layer is preferably 50% by mass or more, more preferably 50% by mass to 99% by mass, still more preferably 55% by mass to 95% by mass in terms of the solid mass, based on the mass of the toner image-receiving layer.

When the amount of the mixture is less than 50% by mass, after the belt fixing of the toner image, the crazing of the toner image-receiving layer is easily caused and the blocking resistance of the image receiving sheet is impaired.

The mixing mass ratio of the water-dispersible rosins in the mixture of the aqueous polymer dispersion and the water-dispersible rosins is preferably 20% by mass or less, more preferably 0.5% by mass to 10% by mass, based on the mass of the mixture.

When the mixing mass ratio of the water-dispersible rosins is more than 20% by mass, the adhesion resistance and resistance to the offset of the image-receiving sheet is lowered sometimes and after the belt fixing of the toner image, the crazing of the image-receiving layer is easily caused sometimes.

The toner image-receiving layer comprises, besides the mixture of the aqueous polymer dispersion and the water-dispersible rosins optionally a releasing agent, a plasticizer (except water-dispersible rosins), a colorant, a filler, a crosslinker, a charge controlling agent, an emulsifying agent, a dispersant and other components.

—Releasing Agent—

The releasing agent is incorporated in the composition of the toner -image-receiving layer for preventing the offset of the toner image-receiving layer.

The releasing agent according to the present invention is not restricted so long as the releasing agent is fused by heating at the fixing temperature, is separated out and present concentrated in the surface of the toner image-receiving layer and further cooled and solidized, so that the releasing agent forms a layer thereof in the surface of the toner image-receiving layer; and may be properly selected depending on the application.

Examples of the releasing agent include a silicone compound, a fluorine compound, a wax and a matting agent.

Examples of the releasing agent include also the compounds described in the literatures “Properties and Applications of Waxes, Revised Edition” (published by Saiwai Shobo) and “The Silicon Handbook” (published by THE NIKKAN KOGYO SHIMBUN). Further, preferred examples of the releasing agent include silicon compounds, fluorine compounds and waxes (except natural waxes) which are used for producing toners which are described in the following patent documents: JP-B Nos. 59-38581, 04-32380, Japanese Patent Nos. 2838498 and 2949558, JP-A Nos. 50-117433, 52-52640, 57-148755, 61-62056, 61-62057, 61-118760, 02-42451, 03-41465, 04-212175, 04-214570, 04-263267, 05-34966, 05-119514, 06-59502, 06-161150, 06-175396, 06-219040, 06-230600, 06-295093, 07-36210, 07-43940, 07-56387, 07-56390, 07-64335, 07-199681, 07-223362, 07-287413, 08-184992, 08-227180, 08-248671, 08-248799, 08-248801, 08-278663, 09-152739, 09-160278, 09-185181, 09-319139, 09-319143, 10-20549, 1048889, 10-198069, 10-207116, 11-2917, 11-44969, 11-65156, 11-73049 and 11-194542. These compounds may be used in combination.

Examples of the silicone compound include a silicone oil, a silicone rubber, silicone fine particles, a silicone-modified resin and a reactive silicone compound.

Examples of the silicone oil include an unmodified silicon oil, an amino-modified silicone oil, a carboxyl-modified silicone oil, a carbinol-modified silicone oil, a vinyl-modified silicone oil, an epoxy-modified silicone oil, a polyether-modified silicone oil, a silanol-modified silicone oil, a methacryl-modified silicone oil, a mercapto-modified silicone oil, an alcohol-modified silicone oil, an alkyl-modified silicone oil and a fluorine-modified silicone oil.

Examples of the silicone-modified resin include silicone-modified resins produced by silicone-modifying resins, such as an olefin resin, a polyester resin, a vinyl resin, a polyamide resin, a cellulose resin, a phenoxy resin, a vinyl chloride-vinyl acetate copolymer resin, an urethane resin, an acrylic resin, a styrene-acrylic copolymer resin and a resin produced by modifying the above-noted copolymers with a silicone.

The fluorine compound is not restricted and may be properly selected depending on the application. Examples of the fluorine compound include a fluorocarbon oil, a fluorocarbon rubber, a fluorine-modified resin, a fluorinated sulfonic acid compound, a fluorosulfonic acid, a fluorine acid compound and a salt thereof and an inorganic fluoride.

The wax is generally classified into a natural wax and a synthesized wax.

Preferred examples of the natural wax include a vegetable wax, an animal wax, a mineral wax and a petroleum wax. Among them, the vegetable wax is most preferred. As the natural wax, particularly from the viewpoint of the compatibility of the wax with a hydrophilic resin used as the polymer for producing the toner image-receiving layer, a water-dispersible natural wax is preferred.

The vegetable wax is not restricted and may be properly selected from conventional vegetable waxes which may be properly synthesized or commercially available. Examples of the vegetable wax include a carnauba wax, a castor oil, a rape oil, a soy bean oil, a Japan tallow, a cotton wax, a rice wax, a sugarcane wax, a candelilla wax, a Japan wax and a jojoba oil.

Examples of the carnauba wax which is commercially available include EMUSTAR-0413 (manufactured and sold by Nippon Seiro Co., Ltd.) and SELOSOL 524 (manufactured and sold by Chukyo Yushi Co., Ltd.). Examples of the castor oil which is commercially available include a purified castor oil (manufactured and sold by Itoh Oil Chemicals Co., Ltd).

Among them, particularly from the viewpoint of providing an image-receiving sheet for the electrophotography which is excellent particularly in resistance to offset, adhesion resistance, conveyability and glossiness, and in which the crazing is difficultly caused and an image having a high quality can be formed, the carnauba wax having a melting point of 70° C. to 95° C. is most preferred.

The animal wax is not restricted and may be properly selected from conventional animal waxes. Examples of the animal wax include a bees wax, a lanolin, a spermaceti wax, a whale oil and a wool wax.

The mineral wax is not restricted and may be properly selected form conventional mineral waxes which may be commercially available or properly synthesized. Examples of the mineral wax include a montan wax, a montan ester wax, an ozokerite and a ceresin.

Among them, particularly from the viewpoint of providing an image-receiving sheet for the electrophotography which is excellent particularly in resistance to offset, adhesion resistance, conveyability and glossiness, and in which the crazing is difficultly caused and an image having a high quality can be formed, the montan wax having a melting point of 70° C. to 95° C. is most preferred.

The petroleum wax is not restricted and may be properly selected conventional petroleum waxes which may be commercially available or properly synthesized. Examples of the petroleum wax include a paraffin wax, a microcrystalline wax and a petrolatum.

The amount of the natural wax in the toner image-receiving layer is preferably 0.1 g/m²to 4 g/m², more preferably 0.2 g/m² to 2 g/m².

When the amount is less than 0.1 g/m², the resistance to offset and adhesion resistance of the image-receiving sheet may be particularly impaired. On the other hand, when the amount is more than 4 g/m², the quality of the image formed on the image-receiving sheet may be impaired due to excessive wax.

The melting point of the natural wax is, particularly from the viewpoint of the resistance to offset and conveyability of the image-receiving sheet, preferably 70° C. to 95° C., more preferably 75° C. to 90° C.

The synthetic wax is classified into a synthetic hydrocarbon, a modified wax, a hydrogenated wax and other synthetic waxes produced from fats and oils.

As the wax, from the viewpoint of the compatibility of the wax with a hydrophilic thermoplastic resin used as a thermoplastic resin for producing the toner image-receiving layer, a water-dispersible wax is preferred.

Examples of the synthetic hydrocarbon include a Fischer-Tropsch wax and a polyethylene wax.

Examples of the synthetic wax produced from fats and oils include an acid amide (e.g., stearamide) and an acid imide (e.g., phthalimide anhydride).

The modified wax is not restricted and may be properly selected depending on the application. Examples of the modified wax include an amine-modified wax, an acrylic acid-modified wax, a fluorine-modified wax, an olefin-modified wax, a urethane wax and an alcohol wax.

The hydrogenated wax is not restricted and may be properly selected depending on the application. Examples of the hydrogenated wax include a hard castor oil, a castor oil derivative, stearic acid, lauric acid, myristic acid, palmitic acid, behenic acid, sebacic acid, undecylenic acid, heptylic acid, maleic acid and a highly maleinated oil.

The above-noted matting agent is not restricted and may be properly selected from conventional matting agents depending on the application. Examples of solid particles used as a matting agent include inorganic particles and organic particles. Specific examples of the inorganic particles used as an inorganic matting agent include particles of an oxide (e.g., silicone dioxide, titanium oxide, magnesium oxide and aluminum oxide), an alkaline earth metal salt (e.g., barium sulfate, calcium carbonate and magnesium sulfate), a silver halide (e.g., silver chloride and silver bromide) and a glass.

Examples of the inorganic matting agent comprising the inorganic particles include matting agents described in patent documents, such as West German Patent No. 2529321; G.B. Patent Nos. 760775 and 1260772; and U.S. Pat. Nos. 1,201,905, 2,192,241, 3,053,662, 3,062,649, 3,257,206, 3,322,555, 3,353,958, 3,370,951, 3,411,907, 3,437,484, 3,523,022, 3,615,554, 3,635,714, 3,769,020, 4,021,245 and 4,029,504.

Examples of the organic particles used as an organic matting agent include particles of a starch, a cellulose ester (e.g., a cellulose acetate propionate), a cellulose ether (e.g., ethyl cellulose) and a synthetic resin. The synthetic resin is preferably a water-insoluble resin or a water-slightly soluble resin. Examples of the water-insoluble resin or the water-slightly soluble resin include a poly(meth)acrylate (e.g., polyalkyl(meth)acrylate, polyalkoxyalkyl(meth)acrylate and polyglycidyl(meth)acrylate), a poly(meth)acrylamide, a polyvinyl ester (e.g., a polyvinyl acetate), a polyacrylonitrile, a polyolefin (e.g., a polyethylene), a polystyrene resin, a benzoguanamine resin, a formaldehyde condensation resin, an epoxy resin, a polyamide resin, a polycarbonate resin, a phenol resin, a polyvinyl carbazole resin and a polyvinylidene chloride resin.

Examples of the above-noted synthetic resin include also a copolymer produced by copolymerizing monomers used for producing the above-noted homopolymers.

The above-noted copolymer may contain a small amount of a hydrophilic recurring unit. Examples of a monomer which forms the above-noted hydrophilic recurring unit include an acrylic acid, a methacrylic acid, a α, β-unsaturated dicarboxylic acid, a hydroxyalkyl(meth)acrylate, a sulfoalkyl(meth)acrylate and a styrenesulfonic acid.

Examples of the organic matting agent comprising the organic particles include matting agents described in patent documents, such as G.B. Patent No. 1055713, U.S. Pat. Nos. 1,939,213, 2,221,873, 2,268,662, 2,322,037, 2,376,005, 2,391,181, 2,701,245, 2,992,101, 3,079,257, 3,262,782, 3,443,946, 3,516,832, 3,539,344, 3,591,379, 3,754,924 and 3,767,448, and JP-A Nos. 49-106821 and 57-14835.

These particles may be used in combination. The volume average particle diameter of the solid particles is preferably 1 μm to 100 μm, more preferably 4 μm to 30 μm. The amount of the solid particles is preferably 0.01 g/m² to 0.5 g/m², more preferably 0.02 g/m² to 0.3 g/m².

The melting point of the releasing agent is, particularly from the viewpoint of the resistance to the offset and conveyability of the image-receiving sheet, preferably 70° C. to 95° C., more preferably 75° C. to 90° C.

As the releasing agent incorporated in the composition of the toner image-receiving layer according to the present invention, a derivative, oxide, purified product and mixture of the above-exemplified releasing agents may be also used. These releasing agents may have a reactive substituent.

The amount of the releasing agent in the toner image-receiving layer is preferably 0.1% to 10% by mass, more preferably 0.3% to 8.0% by mass, still more preferably 0.5% to 5.0% by mass, based on the mass of the toner image-receiving layer. When the amount is less than 0.1% by mass, the resistance to the offset and adhesion resistance of the toner image-receiving sheet are unsatisfactory sometimes. On the other hand, when the amount is more than 10% by mass, the quality of the formed image is impaired due to excessive releasing agent sometimes.

—Plasticizer—

The plasticizer (except the water-dispersible rosins) is not restricted and may be properly selected from conventional plasticizers used for the resin depending on the application. The plasticizer has the function of controlling the fluidizing and softening of the toner image-receiving layer by the heat and pressure applied on the toner image-receiving layer during fixing the toner.

Examples of a reference for selecting the plasticizer include literatures, such as “Kagaku Binran (Chemical Handbook)” (edited by The Chemical Society of Japan and published by Maruzen Co., Ltd.), “Plasticizer, Theory and Application” (edited by Koichi Murai and published by Saiwai Shobo), “Volumes 1 and 2 of Studies on Plasticizer” (edited by Polymer Chemistry Association) and “Handbook on Compounding Ingredients for Rubbers and Plastics” (edited by Rubber Digest Co.).

Some plasticizers are described as an organic solvent having a high boiling point or a thermal solvent in some literatures. Examples of the plasticizer include esters (e.g., phthalate esters, phosphorate esters, fatty esters, abietate esters, adipate esters, sebacate esters, azelate esters, benzoate esters, butyrate esters, epoxidized fatty esters, glycolate esters, propionate esters, trimellitate esters, citrate esters, sulfonate esters, carboxylate esters, succinate esters, malate esters, fumarate esters, phthalate esters and stearate esters); amides (, such as fatty amides and sulfonate amides); ethers; alcohols; lactones and polyethylene oxides, which are described in patent documents, such as JP-A Nos. 59-83154, 59-178451, 59-178453, 59-178454, 59-178455, 59-178457, 62-174754, 62-245253, 61-209444, 61-200538, 62-8145, 62-9348, 62-30247, 62-136646, and 2-235694.

These plasticizers may be incorporated in the composition of the resin.

Further, a plasticizer having a relatively low molecular weight can be also used. The plasticizer has a molecular weight which is preferably lower than that of a binder resin which is plasticized by the plasticizer and preferably 15,000 or less, more preferably 5,000 or less. In addition, when a plasticizer is a polymer, the plasticizer is preferably the same polymer as that of the binder resin which is plasticized by the plasticizer. For example, for plasticizing a polyester resin, the plasticizer is preferably a polyester having a low molecular weight. Further, an oligomer can be also used as a plasticizer.

Besides the above-exemplified plasticizer, examples of the plasticizer which is commercially available include Adekacizer PN-170 and PN-1430 (manufactured and sold by Asahi Denka Kogyo Co., Ltd.); PARAPLEX G-25, G-30 and G40 (manufactured and sold by C. P. Hall Co., Ltd.); and Ester Gum 8L-JA, Ester R-95, Pentalin 4851, FK 115, 4820, 830, Luisol 28-JA, Picolastic A75, Picotex LC and Crystalex 3085 (manufactured and sold by Rika Hercules Co., Ltd.).

The plasticizer may be randomly used for relaxing the stress and strain (i.e., a physical strain, such as an elastic force and a viscosity; and a strain due to a material balance in the molecule and the backbone chain and pendant moiety of the binder) which are caused when the toner particles are embedded in the toner image-receiving layer.

In the toner image-receiving layer, the plasticizer may be finely (microscopically) dispersed, may be in the state of a fine phase-separation in a sea-island structure and may be compatibilized with other components, such as a binder resin.

The amount of the plasticizer in the toner image-receiving layer is preferably 0.001% by mass to 90% by mass, more preferably 0.1% by mass to 60% by mass, still more preferably 1% by mass to 40% by mass, based on the mass of the toner image-receiving layer.

The plasticizer may be used for controlling slip properties (for improving the conveyability by reducing the friction), improving the offset of the toner at the fixing part of the fixing apparatus (peeling of the toner or the toner image-receiving layer to the fixing part), controlling the curling balance and controlling the electrostatic charge (formation of a toner electrostatic image).
—Colorant—

The colorant is not restricted and may be properly selected depending on the application. Examples of the colorant include a fluorescent whitening agent, a white pigment, a colored pigment and a dye.

The fluorescent whitening agent is not restricted so long as the agent is a conventional compound having the absorption in the near-ultraviolet region and emitting a fluorescence having a wavelength of 400 nm to 500 nm and may be properly selected from conventional fluorescent whitening agents. Preferred examples of the fluorescent whitening agent include the compounds described in the literature “The Chemistry of Synthetic Dyes, Volume V” (edited by K. Veen Rataraman, Chapter 8). The fluorescent whitening agent may be a commercially available product or a properly synthesized product. Examples of the fluorescent whitening agent include stilbene compounds, coumarin compounds, biphenyl compounds, benzo-oxazoline compounds, naphthalimide compounds, pyrazoline compounds and carbostyryl compounds. Examples of the commercially available fluorescent whitening agent include white furfar-PSN, PHR, HCS, PCS and B (manufactured and sold by Sumitomo Chemicals Co., Ltd.) and UVITEX-OB (manufactured and sold by Ciba-Geigy Corp.).

The white pigment is not restricted and may be properly selected from conventional white pigments depending on the application. Examples of the white pigment include an inorganic pigment, such as titanium oxide and calcium carbonate.

The colored pigment is not restricted and may be properly selected from conventional colored pigments. Examples of the colored pigment include various pigments described in JP-A No. 63-44653, such as an azo pigment, a polycyclic pigment, a condensed polycyclic pigment, a lake pigment and a carbon black.

Examples of the azo pigment include an azo lake pigment (e.g., carmine 6B and red 2B), an insoluble azo pigment (e.g., monoazo yellow, disazo yellow, pyrazolone orange and Vulcan orange) and a condensed azo pigment (e.g., chromophthal yellow and chromophthal red).

Examples of the polycyclic pigment include a phthalocyanine pigment, such as copper phthalocyanine blue and copper phthalocyanine green.

Examples of the condensed polycyclic pigment include a dioxazine pigment (e.g., dioxazine violet), an isoindolinone pigment (e.g., isoindolinone yellow), a threne pigment, a perylene pigment, a perinone pigment and a thioindigo pigment.

Examples of the lake pigment include malachite green, rhodamine B, rhodamine G and Victoria blue B.

Examples of the inorganic pigment include an oxide (e.g., titanium dioxide and iron oxide red), a sulfate salt (e.g., precipitated barium sulfate), a carbonate salt (e.g., precipitated calcium carbonate), a silicate salt (e.g., a hydrous silicate salt and an anhydrous silicate salt) and a metal powder (e.g., aluminum powder, bronze powder, zinc powder, chrome yellow and iron blue).

These pigments may be used individually or in combination.

The dye is not restricted and may be properly selected from conventional dyes depending on the application. Examples of the dye include anthraquinone compounds and azo compounds. These dyes may be used individually or in combination.

Examples of the water-insoluble dye include a vat dye, a disperse dye and an oil-soluble dye. Specific examples of the vat dye include C. I. Vat violet 1, C. I. Vat violet 2, C. I. Vat violet 9, C. I. Vat violet 13, C. I. Vat violet 21, C. I. Vat blue 1, C. I. Vat blue 3, C. I. Vat blue 4, C. I. Vat blue 6, C. I. Vat blue 14, C. I. Vat blue 20 and C. I. Vat blue 35. Specific examples of the disperse dye include C. I. disperse violet 1, C. I. disperse violet 4, C. I. disperse violet 10, C. I. disperse blue 3, C. I. disperse blue 7 and C. I. disperse blue 58. Specific examples of the oil-soluble dye include C. I. solvent violet 13, C. I. solvent violet 14, C. I. solvent violet 21, C. I. solvent violet 27, C. I. solvent blue 11, C. I. solvent blue 12, C. I. solvent blue 25 and C. I. solvent blue 55.

Colored couplers used in the silver halide photography may also be used preferably as the dye.

The amount of the colorant in the toner image-receiving layer is preferably 0.1 g/m²to 8 g/m², more preferably 0.5 g/m² to 5 g/m².

When the amount of the colorant is less than 0.1 g/m², the light transmittance of the toner image-receiving layer becomes high sometimes. On the other hand, when the amount is more than 8 g/m², the handling properties of the toner image-receiving sheet, such as the resistance to the crazing and the adhesion resistance are impaired sometimes.

The amount of the pigment among the above-noted colorants is preferably 40% by mass or less, more preferably 30% by mass or less, still more preferably 20% by mass or less, based on the mass of the thermoplastic resin composing the toner image-receiving layer.

Examples of the filler include an organic filler and an inorganic filler which is a conventional reinforcing agent, filler or reinforcer for the binder resin. The filler may be properly selected with referring to “Handbook of Rubber and Plastics Additives” (edited by Rubber Digest Co.), “Plastics Blending Agents—Basics and Applications” (New Edition) (published by Taisei Co.) and “The Filler Handbook” (published by Taisei Co.).

Examples of the filler include an inorganic filler and an inorganic pigment. Specific examples of the inorganic filler or the inorganic pigment include silica, alumina, titanium dioxide, zinc oxide, zirconium oxide, micaceous iron oxide, white lead, lead oxide, cobalt oxide, strontium chromate, molybdenum pigments, smectite, magnesium oxide, calcium oxide, calcium carbonate and mullite. Among them, silica and alumina are most preferred. These fillers may be used individually or in combination. It is preferred that the filler has a small particle diameter. When the filler has a large particle diameter, the surface of the toner image-receiving layer is easily roughened.

Examples of the silica include a spherical silica and an amorphous silica. The silica can be synthesized according to a dry method, a wet method or an aerogel method. The silica may be also produced by treating the surface of hydrophobic silica particles with a trimethylsilyl group or silicone. Preferred examples of the silica include a colloidal silica. The silica is preferably porous.

Examples of the alumina include an anhydrous alumina and an alumina hydrate. Examples of the crystal form of anhydrous alumina include α-, β-, γ-, δ-, ξ-, η-, θ-, κ-, ρ- and χ-. The alumina hydrate is more preferred than the anhydrous alumina. Examples of the alumina hydrate include an alumina monohydrate and an alumina trihydrate. Examples of the alumina monohydrate include pseudo-boehmite, boehmite and diaspore. Examples of the alumina trihydrate include gibbsite and bialite. The alumina is preferably porous.

The alumina hydrate can be synthesized according to the sol-gel method in which ammonia is added to a solution of an aluminum salt to precipitate alumina or a method of hydrolyzing an alkali aluminate. The anhydrous alumina can be obtained by dehydrating an alumina hydrate by the heating.

The amount of the filler is preferably 5 parts by mass to 2,000 parts by mass, relative to 100 parts by mass (in terms of dry mass) of the binder resin in the toner image-receiving layer.

The crosslinker may be incorporated in the resin composition of the toner image-receiving layer for controlling the shelf stability and thermoplasticity of the toner image-receiving layer. Examples of the crosslinker include a compound containing in the molecule two or more reactive groups selected from the group consisting of an epoxy group, an isocyanate group, an aldehyde group, an active halogen group, an active methylene group, an acetylene group and other conventional reactive groups.

Examples of the crosslinker include, besides the above-noted examples also a compound containing in the molecule two or more groups which can form a bonding through a hydrogen bonding, an ionic bonding or a coordination bonding.

Specific examples of the crosslinker include a conventional coupling agent, curing agent, polymerizing agent, polymerization promoter, coagulant, film-forming agent and film-forming assistant which are used for the resin. Examples of the coupling agent include chlorosilanes, vinylsilanes, epoxisilanes, aminosilanes, alkoxy aluminum chelates, titanate coupling agents and other conventional crosslinkers described in the literature “Handbook of Rubber and Plastics Additives” (edited by Rubber Digest Co.).

The toner image-receiving layer according to the present invention preferably comprises a charge controlling agent for controlling the transfer and adhesion of the toner or for preventing the adhesion of the toner image-receiving layer due to the charge.

The charge controlling agent is not restricted and may be properly selected from conventional various charge controlling agents depending on the application. Examples of the charge controlling agent include a surfactant, such as a cationic surfactant, an anionic surfactant, an amphoteric surfactant and a non-ionic surfactant; a polymer electrolyte and a conductive metal oxide. Specific examples of the charge controlling agent include a cationic antistatic agent, such as a quaternary ammonium salt, a polyamine derivative, a cation-modified polymethyl methacrylate and a cation-modified polystyrene; an anionic antistatic agent, such as an alkyl phosphate and an anionic polymer; and a non-ionic antistatic agent, such as a fatty ester and a polyethylene oxide.

When the toner is negatively charged, the charge controlling agent incorporated in the toner image-receiving layer is preferably a cationic or nonionic charge controlling agent.

Examples of the conductive metal oxide include ZnO, TiO₂, SnO₂, Al₂₃, In₂O₃, SiO₂, MgO, BaO and MoO₃. These conductive metal oxides may be used individually or in combination. The conductive metal oxide may contain (dope) another different element, for example, ZnO may contain (dope) Al and In; TiO₂ may contain (dope) Nb and Ta; and SnO₂ may contain (dope) Sb, Nb and a halogen element.

—Other Additives—

The toner image-receiving layer according to the present invention may comprise also various additives for improving the stability of the output image or the stability of the toner image-receiving layer itself. Examples of the additive include various conventional antioxidants, anti-aging agents, deterioration inhibitors, ozone-deterioration inhibitors, ultraviolet light absorbers, metal complexes, light stabilizers, antiseptic agents and anti-fungus agents.

The antioxidant is not restricted and may be properly selected depending on the application. Examples of the antioxidant include a chroman compound, a coumarin compound, a phenol compound (e.g., a hindered phenol), a hydroquinone derivative, a hindered amine derivative and a spiroindan compound. With respect to the antioxidant, there is a description in JP-A No. 61-159644.

The anti-aging agent is not restricted and may be properly selected depending on the application. Examples of the anti-aging agent include anti-aging agents described in the literature “Handbook of Rubber and Plastics Additives—Revised Second Edition” (published by Rubber Digest Co., 1993, pp. 76-121).

The ultraviolet light absorber is not restricted and may be properly selected depending on the application. Examples of the ultraviolet light absorber include a benzotriazol compound (see U.S. Pat. No. 3,533,794), a 4-thiazolidone compound (see U.S. Pat. No. 3,352,681), a benzophenone compound (see JP-A No. 46-2784) and an ultraviolet light absorbing polymer (see JP-A No. 62-260152).

The metal complex is not restricted and may be properly selected depending on the application. Proper examples of the metal complex include metal complexes described in patent documents, such as U.S. Pat. Nos. 4,241,155, 4,245,018, and 4,254,195; and JP-A Nos. 61-88256, 62-174741, 63-199248, 01-75568 and 01-74272.

Also, preferred examples of the ultraviolet light absorber or the light stabilizer include ultraviolet light absorbers or light stabilizers described in the literature “Handbook on Compounding Ingredients for Rubbers and Plastics, revised second edition” (published by Rubber Digest Co., 1993, pp. 122-137).

The toner image-receiving layer may optionally comprise the above-noted conventional additives for the photography. Examples of the additive for the photography include additives described in the literatures “Journal of Research Disclosure (hereinafter referred to as RD) No. 17643 (December, 1978), No. 18716 (November, 1979) and No. 307105 (November, 1989)”. These additives are specifically noted with respect to the pages of the Journal RD which are to be referred to a table as shown in the following Table 1.

TABLE 1

| | | Journal No. | | |
|---|---|---|---|---|
| Type of additives | | RD17643 | RD18716 | RD307105 |
| 1. | Whitening agent | pp. 24 | p. 648 right column | pp. 868 |
| 2. | Stabilizer | pp. 24-25 | p. 649 right column | pp. 868-870 |
| 3. | Light absorber | pp. 25-26 | p. 649 right column | pp. 873 |
| | (Ultraviolet light | | | |
| | absorber) | | | |
| 4. | Dye image stabilizer | pp. 25 | p. 650 right column | pp. 872 |
| 5. | Film hardener | pp. 26 | p. 651 left column | pp. 874-875 |
| 6. | Binder | pp. 26 | p. 651 left column | pp. 873-874 |
| 7. | Plasticizer, | pp. 27 | p. 650 right column | pp. 876 |
| | lubricant | | | |
| 8. | Auxiliary coating | pp. 26-27 | p. 650 right column | pp. 875-876 |
| | agent (Surfactant) | | | |
| 9. | Antistatic agent | pp. 27 | p. 650 right column | pp. 876-877 |
| 10. | Matting agent | | | pp. 878-879 |

The toner image-receiving layer is disposed on the support by coating the support with the coating liquid containing a thermoplastic resin used for producing the toner image-receiving layer using a wire coater and by drying the resultant coating. The Minimum Film Forming Temperature (MFT) of the thermoplastic resin according to the present invention is preferably room temperature or higher during the storage of the image-receiving sheet before the printing and preferably 100° C. or lower during the fixing of the toner particles.

The mass of the dried coating as the toner image-receiving layer is preferably 1 g/m² to 20 g/m², more preferably 4 g/m² to 15 g/m².

The thickness of the toner image-receiving layer is not restricted and may be properly selected depending on the application. The thickness is preferably ½ or more of the diameter of the toner particles, more preferably from 1 time to 3 times the diameter of the toner particles. More specifically, the thickness is preferably from 1 μm to 50 μm, more preferably from 1 μm to 30 μm, still more preferably from 2 μm to 20 μm, most preferably from 5 μm to 15 μm.

[Physical Properties of Toner Image-Receiving Layer]

The 180-degree peel strength of the toner image-receiving layer at the temperature for the image-fixing at which the image is fixed on the fixing member is preferably 0.1 N/25 mm or less, more preferably 0.041 N/25 mm or less. The 180-degree peel strength can be measured according to the method described in JIS K 6887 using a surface material of the fixing member.

It is preferred that the toner image-receiving layer has the whiteness of a high degree. The whiteness is measured by the method described in JIS P 8123 and is preferably 85% or more. It is preferred that the spectral reflectance of the toner image-receiving layer is 85% or more in the wavelength range of from 440 nm to 640 nm and the difference between the maximum spectral reflectance and minimum spectral reflectance of the toner image-receiving layer in the above-noted wavelength range is 5% or less. Further, it is more preferred that the spectral reflectance of the toner image-receiving layer is 85% or more in the wavelength range of from 400 to 700 nm and the difference between the maximum spectral reflectance and minimum spectral reflectance of the toner image-receiving layer in the above-noted wavelength range is 5% or less.

With respect to the whiteness of the toner image-receiving layer, specifically, in the CIE 1976 (L* a* b*) color space, an L* value is preferably 80 or more, more preferably 85 or more, still more preferably 90 or more. The tone of the whiteness is preferably as neutral as possible and more specifically, with respect to the tone of the whiteness of the toner image-receiving layer, in the (L* a* b*) space, the value of (a*)²+(b*)² is preferably 50 or less, more preferably 18 or less, still more preferably 5 or less.

The toner image-receiving layer has preferably high glossiness after the image-forming. With respect to the gloss level of the toner image-receiving layer, through the range of from the state in which the toner image-receiving layer is white (i.e., there is no toner in the toner image-receiving layer) to the state in which the toner image-receiving layer is black (i.e., there is full of the toner in the toner image-receiving layer), the 45-degree gloss level of the toner image-receiving layer is preferably 60 or more, more preferably 75 or more, still more preferably 90 or more.

However, the gloss level of the toner image-receiving layer is preferably 110 or less. When the gloss level is more than 110, the image has a metallic luster and such a quality of the image is undesirable.

The gloss level can be measured according to JIS Z 8741.

The toner image-receiving layer has preferably high smoothness after the fixing. With respect to the smoothness degree of the toner image-receiving layer, through the range of from the state in which the toner image-receiving layer is white (i.e., there is no toner in the toner image-receiving layer) to the state in which the toner image-receiving layer is black (i.e., there is full of the toner in the toner image-receiving layer), the arithmetic average roughness (Ra) of the toner image-receiving layer is preferably 3 μm or less, more preferably 1 μm or less, still more preferably 0.5 μm or less.

The arithmetic average roughness can be measured, for example, according to the methods described in JIS B 0601, B 0651 and B 0652.

The toner image-receiving layer has preferably one of the physical properties described in the following items (1) to (6), more preferably several of them, most preferably all of them.
(1) The melt temperature (Tₘ) of the toner image-receiving layer is 30° C. or higher and is a temperature which is higher than Tₘ of the toner by 20° C., or lower.
(2) The temperature at which the viscosity of the toner image-receiving layer is 1×10⁵ cp is 40° C. or higher and is a temperature which is lower than the temperature at which the viscosity of the toner is 1×10⁵ cp.
(3) The storage elasticity modulus (G′) of the toner image-receiving layer at the temperature for the image-fixing is from 1×10² Pa to 1×10⁵ Pa and the loss elasticity modulus (G″) of the toner image-receiving layer at the temperature for the image-fixing is from 1×10² Pa to 1×10⁵ Pa.
(4) The loss tangent (G″/G′) of the toner image-receiving layer is from 0.01 to 10, wherein the loss tangent is the ratio of the loss elasticity modulus (G″) to the storage elasticity modulus (G′).
(5) The storage elasticity modulus (G′) of the toner image-receiving layer at the fixing temperature differs from the storage elasticity modulus (G′) of the toner at the fixing temperature by −50 to +2500.
(6) The inclination angle of the molten toner on the toner image-receiving layer is preferably 50° or less, more preferably 40° or less.

The toner image-receiving layer satisfies the physical properties described in Japanese Patent No. 2788358 and JP-A Nos. 07-248637, 08-305067 and 10-239889.

The toner image-receiving layer has a surface electrical resistance of preferably in the range of from 1×10⁶ Ω/cm² to 1×10¹⁵ Ω/cm² (under conditions of 25° C. and 65% RH).

When the surface electrical resistance is less than 1×10⁶ Ω/cm², the amount of the toner transferred to the toner image-receiving layer is unsatisfactory, so that a disadvantage is caused wherein the density of the obtained toner image is easily lowered sometimes. On the other hand, when the surface electrical resistance is more than 1 x 1015 U/cm², more charge than the necessity is generated in the toner image-receiving layer during the transfering, so that disadvantages are caused wherein the toner is transferred so unsatisfactorily that the density of the obtained image is low and the image-receiving sheet for the electrophotography is electrostatically charged, so that the image-receiving sheet adsorbs easily the dust. Moreover, in this case, miss field, multi feed, discharge marks and toner transferring omission are caused during the copying sometimes.

The surface electrical resistance of the toner image-receiving layer can be measured according to the method described in JIS K 6911 as follows. The sample of the toner image-receiving layer is left under the condition where the temperature is 20° C. and the humidity is 65% for 8 hours or more and using a micro-ammeter R8340 (manufactured and sold by Advantest Ltd.), after applying a voltage of 100 V to the sample of the toner image-receiving layer for 1 minute under the same condition as the above-noted condition, the surface electrical resistance of the toner image-receiving layer can be measured.

[Support]

The support is not restricted and may be properly selected depending on the application.

Examples of the support include a raw paper, a synthetic paper, a synthetic resin sheet, a coated paper and a laminated paper. The support may be in a structure of a single layer or in a laminated structure of plural layers. Among them, the support produced by disposing polyolefin resin layers on the both surfaces of the raw paper is preferred from the viewpoint of the smoothness and glossiness and the stretchability of the support.

—Raw Paper—

The raw paper is not restricted and may be properly selected depending on the application. Preferred specific examples of the raw paper include a woodfree paper, such as a paper described in the literature “Basis of Photographic Technology-silver halide photograph (edited by The Society of Photographic Science and Technology of Japan and published by Corona Publishing Co., Ltd. (1979) (pp. 223-224) )”.

For imparting a desired mean center line roughness to the surface of the raw paper, it is preferred that the raw paper is produced, as described in JP-A No. 58-68037, using a pulp fiber having a fiber length distribution in which a total amount of a 24 mesh screen remnant and a 42 mesh screen remnant is from 20% to 45% by mass and an amount of a 24 mesh screen remnant is 5% by mass or less, based on the mass of all pulp fibers. Moreover, the mean center line roughness of the raw paper can be controlled by subjecting the raw paper to a surface treatment by applying the heat and pressure to the raw paper using a machine calendar or a super calendar.

The raw paper is not restricted so long as the raw paper is a conventional material used for producing the support and may be properly selected from various materials depending on the application. Examples of the material for the raw paper include a natural pulp made from a needle-leaf tree or a broadleaf tree and a mixture of the natural pulp and the synthetic pulp.

As a pulp which can be used as a material for the raw paper, from the viewpoint of improving simultaneously the surface smoothness, the stiffness and the dimensional stability (curling properties) of the raw paper in a good balance and to a satisfactory level, broadleaf tree bleached craft pulp (LBKP) is preferred. Needle-leaf bleached craft pulp (NBKP) and broadleaf tree sulfite pulp (LBSP) can be also used.

For beating the pulp, a beater or a refiner can be used.

From the viewpoint of the capability of controlling the shrinkage of the paper in the papermaking, the Canadian Standard Freeness (CSF) of the pulp is preferably from 200 ml CSF to 440 ml CSF, more preferably from 250 ml CSF to 380 ml CSF.

The pulp slurry (hereinafter, referred to as “pulp paper material” sometimes) which is obtained after beating the pulp comprises optionally various additives, such as a filler, a dry paper reinforcer, a sizing agent, a wet paper reinforcer, an adhesion promoter, a pH controller and other agents.

Examples of the filler include calcium carbonate, a clay, a kaolin, a white clay, a talc, titanium oxide, a diatomaceous earth, barium sulfate, aluminum hydroxide and magnesium hydroxide.

Examples of the dry paper reinforcer include cationic starch, cationic polyacrylamide, anionic polyacrylamide, amphoteric polyacrylamide, carboxy-modified polyvinyl alcohol.

Examples of the sizing agent include a fatty acid salt; a rosin derivative, such as a rosin and a maleic rosin; a paraffin wax; and a compound containing a higher fatty acid, such as an alkyl ketene dimmer, an alkenyl succinic anhydride (ASA) and an epoxidized fatty amide.

Examples of the wet paper reinforcer include a polyamidepolyamineepichlorohydrin resin, a melamine resin, a urea resin and an epoxidized polyamide resin.

Examples of the adhesion promoter include a multivalent metal salt, such as aluminum sulfate and aluminum chloride; and a cationic polymer, such as a cationic starch.

Examples of the pH controller include caustic soda and sodium carbonate.

Examples of the other agents include an anti-foaming agent, a dye, a slime controlling agent and a fluorescent whitening agent.

Further optionally, the pulp slurry may comprise a flexibilizer. Examples of the flexibilizer include an agent described in the literature “Paper and Paper Treatment Manual (published by Shiyaku Time Co., Ltd. (1980) (pp. 554-555) ).

These various additives may be used individually or in combination. The amount of the various additives in the pulp paper material is not restricted and may be selected properly depending on the application. The amount is preferably 0.1% by mass to 1.0% by mass, based on the mass of the pulp paper material.

The pulp paper material (which is optionally prepared by incorporating the various additives into the pulp slurry) is subjected to the papermaking using a paper machine, such as a manual paper machine, a Fourdrinier (long-net) paper machine, a round-net paper machine, a twin-wire machine and a combination machine and the made paper is dried, thereby preparing the raw paper. If desired, either before or after the drying of the made paper, the made paper may be subjected to the surface sizing treatment.

The treating liquid used for the surface sizing treatment is not restricted and may be properly selected depending on the application. Examples of the compound contained in the treating liquid include a water-soluble polymer, a waterproof compound, a pigment, a dye and a fluorescent whitening agent.

Examples of the water-soluble polymer include a cationic starch, a polyvinyl alcohol, a carboxy-modified polyvinyl alcohol, a carboxymethyl cellulose, a hydroxyethyl cellulose, a cellulose sulfate, a gelatin, a casein, a sodium salt of a polyacrylate, a sodium salt of a styrene-maleic anhydride copolymer and a sodium salt of a polystyrenesulfonic acid.

Examples of the waterproof compound include latexes and emulsions, such as a styrene-butadiene copolymer, an ethylene-vinyl acetate copolymer, a polyethylene and a vinylidene chloride copolymer; and a polyamidepolyamineepichlorohydrin.

Examples of the pigment include calcium carbonate, a clay, a kaolin, a talc, barium sulfate and titanium oxide.

From the viewpoint of improving stiffness and dimensional stability (curling properties) of the raw paper, it is preferred that the raw paper has the ratio (Ea/Eb) between the longitudinal Young's modulus (Ea) and the lateral Young's modulus (Eb) of from 1.5 to 2.0. When the ratio (Ea/Eb) is less than 1.5 or more than 2.0, the stiffness and the curling properties of the image-receiving sheet for the electrophotography may be easily impaired, so that a disadvantage is caused wherein the conveyability of the image-receiving sheet for the electrophotography is hindered.

Generally, it has been clarified that the “nerve” of the paper is varied depending on the method for beating the pulp and as an important index indicating the “nerve” of the paper, the modulus of elasticity of the paper made by the papermaking after the beating of the pulp, can be used. The modulus of elasticity of the paper can be calculated according to the following equation:
E=ρc²(1−n²)
where “E” represents dynamic modulus, “ρ” represents the density of the paper, “c” represents the velocity of sound in the paper, and “n” represents the Poisson's ratio, by utilizing the relation between the dynamic modulus of the paper indicating the properties as a viscoelastic body and the density of the paper, and the velocity of sound in the paper measured using an ultrasonic oscillator.

In addition, since, with respect to a plain paper n is around 0.2, there is not much difference between the calculation of the dynamic modulus according to the above-noted equation and the calculation according to the following equation:
E=ρc².

Accordingly, when the density of the paper and the velocity of sound in the paper can be measured, the elastic modulus of the paper can be easily calculated. For measuring the velocity of sound in the paper, various conventional instruments, such as a Sonic Tester SST-110 (manufactured and sold by Nomura Shoji Co., Ltd.) can be used.

The thickness of the raw paper is not restricted and may be properly selected depending on the application; however usually, the thickness is preferably 30 μm to 500 μm, more preferably 50 μm to 300 μm, still more preferably 100 μm to 250 μm. The basis weight of the raw paper is not restricted and may be properly selected depending on the application. The basis weight is preferably 50 g/m² to 250 g/m², more preferably 100 g/m² to 200 g/m².

—Synthetic Paper—

The synthetic paper is a paper comprising mainly another polymer fiber than a cellulose and examples of the another polymer fiber include a polyolefin fiber, such as a polyethylene fiber and a polypropylene fiber.

—Synthetic Resin Sheet (Film)—

Examples of the synthetic resin sheet (film) include a synthetic resin shaped into the form of a sheet, such as a polypropylene film, an oriented polyethylene film, an oriented polypropylene film, a polyester film, an oriented polyester film and a nylon film. In addition, a film whitened by orienting the film and a white film comprising a white pigment can be also used.

—Coated Paper—

The coated paper is a paper produced by coating either a single surface or the both surfaces of the support, such as the raw paper with various resins and the amount of a resin as a coating material is varied depending on the application of the coated paper. Examples of the coated paper include an art paper, a cast-coated paper and a Yankee paper.

The resin with which the surface of the raw paper is coated is not restricted and may be properly selected depending on the application. The resin is preferably a thermoplastic resin. Examples of the thermoplastic resin include (1) polyolefin resins and derivatives thereof, (2) polystyrene resins, (3) acrylic resins, (4) a polyvinyl acetate and derivatives thereof, (5) polyamide resins, (6) a polyester resin, (7) a polycarbonate resin, (8) a polyether resin (or an acetal resin), and (9) other resins. These thermoplastic resins may be used individually or in combination. As the resins (1) to (9), the same resins as the resins used for producing the toner image receiving layer can be used.

—Laminated Paper—

The laminated paper is a paper produced by laminating a material for the laminating, such as various resins, a rubber, a polymer sheet or a polymer film on the surface of the support, such as the raw paper. Examples of the material for the laminating include a polyolefin resin, a polyvinyl chloride resin, a polyester resin, a polystyrene resin, a polymethacrylate resin, a polycarbonate resin, a polyimide resin and a triacetyl cellulose resin. These resins may be used individually or in combination.

Generally, the polyolefin resin is frequently produced using a low-density polyethylene resin. For improving the heat resistance of the support, however, it is preferred to produce the polyolefin resin using a polypropylene resin, a mixture of a polypropylene resin and a polyethylene resin, a high-density polyethylene resin or a mixture of a high-density polyethylene resin and a low-density polyethylene resin. Particularly from the viewpoint of the cost and the suitability for laminating, it is most preferred to produce the polyolefin resin using the mixture of a high-density polyethylene resin and a low-density polyethylene resin.

The mixing ratio (in terms of the mass ratio) between the high-density polyethylene and the low-density polyethylene is preferably 1:9 to 9:1, more preferably 2:8 to 8:2, still more preferably 3:7 to 7:3.

For disposing thermoplastic resin layers on the both surfaces of the raw paper, it is preferred that on the reverse surface of the raw paper, a thermoplastic resin layer is disposed using a high-density polyethylene resin or a mixture of a high-density polyethylene resin and a low-density polyethylene resin. The molecular weight of the polyethylene resin is not restricted and may be properly selected depending on the application; however, it is preferred that with respect to the both of a high-density polyethylene resin and a low-density polyethylene resin, the polyethylene resin has the melt index of 1.0 g/10 min to 40 g/10 min and has the suitability for extruding.

The polymer sheet or the polymer film as the above-noted material for the laminating may be subjected to a treatment of imparting the white reflectivity. Examples of the treatment of imparting the white reflectivity include a method for incorporating a pigment, such as titanium oxide in the composition of the polymer sheet or the polymer film.

The support has a thickness of preferably 25 μm to 300 μm, more preferably 50 μm to 260 μm, still more preferably 75 μm to 220 μm. The stiffness of the support may be selected depending on the application. The support for producing the image-receiving sheet for the electrophotography has preferably similar stiffness to that of the support for producing the image-receiving sheet for the color silver salt-photography.

[Other Layers]

Examples of the other layers of the image-receiving sheet for the electrophotography include a surface protecting layer, an adhesion improving layer, an intermediate layer, an undercoating layer, a cushion layer, a charge controlling (preventing) layer, a reflective layer, a tint controlling layer, a shelf stability-improving layer, an adhesion preventing layer, an anti-curling layer and a smoothing layer. These layers may be in a single layer structure or a laminated structure of plural layers.

—Surface Protective Layer—

The surface protecting layer may be disposed on the surface of the toner image-receiving layer for protecting the surface of the image-receiving sheet for the electrophotography according to the present invention, improving the shelf stability, handling properties and conveyability thereof, and imparting writing properties and anti-offset properties thereto. The surface protecting layer may have a single-layer structure or a laminated structure of two or more layers. The surface protecting layer may comprise as a binder resin at least one of various thermoplastic resins and thermosetting resins which is preferably a resin of the same type as that of a resin used for producing the toner image-receiving layer. In this case, however, a resin used for producing the surface protecting layer needs not to have the same thermodynamic properties or electrostatic properties as that of a resin used for producing the toner image-receiving layer and those properties of the surface protecting layer can be respectively optimized.

The surface protecting layer comprises the above-noted various additives which can be used for producing the toner image-receiving layer. Particularly, the surface protecting layer may comprise the above-noted releasing agent.

The most outer surface layer of the image-receiving sheet for the electrophotography (e.g., the surface protecting layer when it is disposed) has preferably advantageous compatibility with the toner from the viewpoint of fixability of the toner image. More specifically, the most outer surface layer has preferably a contact angle with the molten toner of from 0° to 40°.

—Back Layer—

The back layer in the image-receiving sheet for the electrophotography according to the present invention is preferably disposed on a surface of the support, which is opposite to another surface of the support on which the toner image-receiving layer is disposed, for imparting back side-output suitability to the image-receiving sheet and improving the image quality of the back side-output, curling balance and conveyability of the image-receiving sheet.

The color of the back layer is not restricted and may be properly selected depending on the application. When the image-receiving sheet for the electrophotography according to the present invention is an image-receiving sheet out-putting the image on the both sides of the image-receiving sheet which forms the image also on the back side, also the color of the back layer is preferably white. The back layer has preferably whiteness of 85% or more and spectral reflectance of 85% or more, like the front side of the image-receiving sheet.

Moreover, for improving both-side output suitability of the image-receiving sheet, the back layer may have the same composition as that of the front side of the sheet which comprises the toner image-receiving layer. The back layer may comprise the above-noted various additives. It is appropriate that as the additives, particularly a charge controlling agent is used. The back layer may have a single-layer structure or a laminated structure of two or more layers.

When for preventing the offset during the image-fixing, an oil having release properties is applied to the fixing roller, the back layer may be oil-absorptive.

Usually, the thickness of the back layer is preferably 0.1 to 10 μm. such as a matting agent. Examples of the matting agent include various

—Adhesion-Improving Layer—

The adhesion-improving layer of the image-receiving sheet for the electrophotography according to the present invention is preferably disposed for improving adhesion between the support and the toner image-receiving layer. The adhesion-improving layer may comprise the above-noted various additives, particularly preferably the crosslinker. Further, it is preferred that in the image-receiving sheet for the electrophotography according to the present invention, for improving the toner-receiving properties of the toner-image receiving layer, a cushion layer is disposed between the adhesion improving layer and the image-receiving layer.

—Intermediate Layer—

The intermediate layer may be, for example, between the support and the adhesion improving layer, between the adhesion improving layer and the cushion layer, between the cushion layer and the toner image-receiving layer, or between the toner image-receiving layer and the shelf stability improving layer. Needless to say, when the image-receiving sheet for the electrophotography comprises the support, the toner image-receiving layer and the intermediate layer, the intermediate layer may be disposed, for example, between the support and the toner image-receiving layer.

The thickness of the image-receiving sheet for the electrophotography according to the present invention is not restricted and may be properly selected depending on the application. The thickness is preferably 50 μm to 500 μm, more preferably 100 μm to 350 μm.

<Toner>

The image-receiving sheet for the electrophotography according to the present invention is used by causing the toner image-receiving layer to receive the toner during the printing or copying.

The toner comprises at least a binder resin and a colorant, and optionally a releasing agent and other components.

—Binder Resin for Toner—

The binder resin is not restricted and may be selected from resins used usually for producing the toner depending on the application. Examples of the binder resin include homo-polymers or copolymers produced by polymerizing or copolymerizing a vinyl monomer or two or more vinyl monomers selected from the group consisting of vinyl monomers, such as styrenes, such as styrene and parachlorostyrene; vinyl esters, such as vinyl naphthalene, vinyl chloride, vinyl bromide, vinyl fluoride, vinyl acetate, vinyl propionate, vinyl benzoate and vinyl butyrate; methylene fatty carboxylate esters, such as methyl acrylate, ethyl acrylate, n-butyl acrylate, isobutyl acrylate, dodecyl acrylate, n-octyl acrylate, 2-chloroethyl acrylate, phenyl acrylate, methyl a-chloroacrylate, methyl methacrylate, ethyl methacrylate and butyl methacrylate; vinyl nitriles, such as acrylonitrile, methacrylonitrile and acrylamide; vinyl ethers, such as vinyl methyl ether, vinyl ethyl ether and vinyl isobutyl ether; N-vinyl compounds, such as N-vinyl pyrrole, N-vinyl carbazole, N-vinyl indole and N-vinyl pyrrolidone; and vinyl carboxylic acids, such as methacrylic acid, acrylic acid and cinnamic acid. Examples of the binder resin include also various polyesters. The above-noted examples of the binder resin may be used in combination with various waxes.

Among these resins, a resin of the same type as that of the resin used for producing the toner image-receiving layer according to the present invention is preferably used.

—Colorant for Toner—

The colorant used for producing the toner is not restricted and may be properly selected from colorants used usually for producing the toner depending on the application. Examples of the colorant include various pigments, such as carbon black, chrome yellow, hansa yellow, benzidine yellow, threne yellow, quinoline yellow, permanent orange GTR, pyrazolone orange, vulcan orange, watchung red, permanent red, brilliant carmine 3B, brilliant carmine 6B, Du Pont Oil Red, pyrazolone red, lithol red, rhodamine B lake, lake red C, rose bengal, aniline blue, ultra marine blue, chalco oil blue, methylene blue chloride, phthalocyanine blue, phthalocyanine green, malachite green oxalate; and various dyes, such as a acridine dye, a xanthene dye, an azo dye, a benzoquinone dye, an azine dye, an anthraquinone dyes, an indigo dye, a thioindigo dye, a dioxazine dye, a thiazine dye, an azomethine dye, a phthalocyanine dye, an aniline black dye, a polymethine dye, a triphenylmethane dye, a diphenylmethane dye and a thiazole dye.

These colorants may be used individually or in combination.

The amount of the colorant is not restricted and may be properly selected depending on the application. The amount is preferably 2% by mass to 8% by mass, based on the mass of the toner. When the amount of the colorant is less than 2% by mass, the coloring power of the toner may be weakened. On the other hand, when the amount is more than 8% by mass, the tranparency of the toner is impaired sometimes.

—Releasing Agent for Toner—

The releasing agent used for producing the toner is not restricted and may be properly selected from releasing agents used usually for producing the toner depending on the application. Particularly effective examples of the releasing agent include a polar wax containing nitrogen, such as a highly-crystalline polyethylene wax having a relatively low molecular weight, a Fischer-Tropsch wax, an amide wax and a compound having a urethane bonding.

The polyethylene wax has a molecular weight of preferably 1,000 or less, more preferable 300 to 1,000.

The compound having a urethane bonding is preferred, because even if the compound has a low molecular weight, the compound can maintain a solid state by a strong cohesive force of a polar group in the compound and such a compound having a high melting point for the molecular weight thereof can be produced. The compound has a molecular weight of preferably 300 to 1,000. Examples of a combination of materials for producing the compound having a urethane bonding include a combination of a diisocyanic acid compound and a monohydric alcohol, a combination of a monoisocyanic acid compound and a monohydric alcohol, a combination of a dihydric alcohol and a monoisocyanic acid compound, a combination of a trihydric alcohol and a monoisocyanic acid compound and a combination of a triisocyanic acid compound and a monohydric alcohol. However, for preventing the production of the compound having a high molecular weight, a combination of a compound having a multiple functional group and another compound having a single functional group is preferred and it is important that the total amount of the functionality in a combination is always equivalent.

Examples of the monoisocyanic acid compound include dodecyl isocyanate, phenyl isocyanate (and a derivative thereof), naphthyl isocyanate, hexyl isocyanate, benzyl isocyanate, butyl isocyanate and allyl isocyanate.

Examples of the diisocyanic acid compound include tolylene diisocyanate, 4,4′ diphenylmethane diisocyanate, toluene diisocyanate, 1,3-phenylene diisocyanate, hexamethylene diisocyanate, 4-methyl-m-phenylene diisocyanate and isophorone diisocyanate.

Examples of the monohydric alcohol include methanol, ethanol, propanol, butanol, pentanol, hexanol and heptanol.

Examples of the dihydric alcohol include various glycols, such as ethylene glycol, diethylene glycol, triethylene glycol and trimethylene glycol.

Examples of the trihydric alcohol include trimethylol propane, triethylol propane and trimethanol ethane.

These urethane compounds may be used, like an usual releasing agent for producing a kneaded-ground toner produced by incorporating the urethane compound together with a resin or a colorant in the toner composition during the kneading. When these urethane compounds are used for producing the toner produced according to the emulsion polymerization-cohesive melting method, an aqueous dispersion of the releasing agent (urethane compound) particles having a size of 1 μm or less is prepared according to a method comprising dispersing in water the urethane compound together with an ionic surfactant and a polymeric electrolyte, such as a polymeric acid and a polymeric base, thereby obtaining a dispersion of the urethane compound, heating the obtained dispersion to the melting point of the urethane compound or higher, and grinding the urethane compound until the urethane compound becomes in the form of fine particles by subjecting the above-noted dispersion to a strong shearing using a homogenizer or a pressure-discharging dispersing apparatus, and the prepared dispersion of fine particles of the urethane compound (releasing agent) is used in combination with a dispersion of resin particles and a dispersion of colorant particles to produce the toner produced according to the emulsion polymerization-cohesive melting method.

—Other Components for Toner—

The toner may comprise other components, such as an inner additive, a charge controlling agent and inorganic fine particles. Examples of the inner additive include a magnetic substance, such as a metal, such as ferrite, magnetite, reduced iron, cobalt, nickel and manganese; an alloy thereof; and a compound containing these metals.

Examples of the charge controlling agent include various charge controlling agents used usually, such as a dye comprising a quaternary ammonium salt, a nigrosine compound or a complex of a metal (e.g., aluminum, iron and chromium) and a triphenylmethane pigment. It is preferred that the charge controlling agent is difficultly dissolved in water, from the view point of controlling the ion strength in the toner, which may affect the stability of the charge controlling agent during the cohesion and the melting and reducing the pollution by the waste water.

Examples of the inorganic fine particles include all outer additives for the toner surface, such as silica, alumina, titania, calcium carbonate, magnesium carbonate and tricalcium phosphate. These particles are preferably used in the form of a dispersion produced by dispersing the particles in an ionic surfactant, a polymer acid or a polymer base.

Further, the toner may comprise as an additive, a surfactant for the emulsion polymerization, the seed emulsion polymerization, the dispersing of the pigment, the dispersing of the resin particles, the dispersing of the releasing agent, the cohesion and the stabilizing of the above-noted operations. Examples of the surfactant include an anionic surfactant, such as a sulfate ester surfactant, a sulfonate salt surfactant, a phosphate ester surfactant and a soap; a cationic surfactant, such as an amine salt surfactant and a quaternary ammonium salt surfactant. It is also effective that the above-exemplified surfactants are used in combination with a nonionic surfactant, such as a polyethylene glycol surfactant, an alkylphenol ethylene oxide adduct surfactant and a polyhydric alcohol surfactant. As a dispersing unit for dispersing the surfactant in the toner, a general unit, such as a rotary-shearing homogenizer; and a ball mill, a sand mill

The toner may optionally comprise an outer additive. Examples of the outer additive include inorganic particles and organic particles. Examples of the inorganic particles include particles of SiO₂, TiO₂, Al₂O₃, CuO, ZnO, SnO₂, Fe₂O₃, MgO, BaO, CaO, K₂O, Na₂O, ZrO₂, CaO.SiO₂, K₂O.(TiO₂)ₙ, AlO₃.2SiO₂, CaCO₃, MgCO₃, BaSO₄ and MgSO₄. Examples of the organic particles include particles of a fatty acid and a derivative thereof; a metal salt of the above-noted fatty acid; and a resin, such as a fluorine resin, a polyethylene resin and an acrylic resin.

The above-noted particles has an average particle diameter of preferably 0.01 μm to 5 μm, more preferably 0.1 μm to 2 μm.

The manufacturing method of the toner is not restricted and may be properly selected depending on the application; however, it is preferred that the toner is produced according to a manufacturing method of the toner comprising (i) preparing a dispersion of cohesive particles of a resin by forming cohesive particles in a dispersion of resin particles, (ii) forming attached particles by mixing the above-prepared dispersion of cohesive particles with a dispersion of fine particles, so that the fine particles attaches to the cohesive particles, thereby forming attached particles and (iii) forming toner particles by heating the attached particles to melt the attached particles.

—Physical Properties of Toner—

The toner according to the present invention has a volume average particle diameter of preferably 0.5 μm to 10 μm. When the volume average particle diameter of the toner is too small, handling properties of the toner (e.g., supplementing properties, cleaning properties and fluidity) may be affected adversely sometimes and the productivity of the particles may be lowered sometimes. On the other hand, when the volume average particle diameter of the toner is too large, the quality and resolution of the image due to the graininess and transferring properties of the toner may be affected adversely sometimes.

It is preferred that the toner according to the present invention satisfies the above-noted range of the volume average particle diameter and has a distribution index of the volume average particle diameter (GSDv) of 1.3 or less.

The ratio (GSDv/GSDn) of the distribution index of the volume average particle diameter (GSDv) to the distribution index of the number average particle diameter (GSDn) is preferably 0.95 or more.

It is preferred that the toner according to the present invention satisfies the above-noted range of the volume average particle diameter and has an average value (of 1.00 to 1.50) of the shape factor calculated according to the following equation:
Shape factor=(π×L²)/(4×S),
wherein L represents the maximum length of the toner particles and S represents the projected area of the toner particles.

The toner satisfying the above-noted conditions has an effect on the image quality, particularly the graininess of the toner and the image resolution. Further, with using such a toner, the omission or blur of the image during the transferring of the image is difficultly caused and the handling properties of the toner may be difficultly affected adversely, even if the average particle diameter of the toner is not small.

From the viewpoint of improving the image quality and preventing the offset during the image-fixing, it is appropriate that the toner has a storage elasticity modulus G′ (as measured at a circular frequency of 10 rad/sec) at 150° C. of 1×10² Pa to 1×10⁵ Pa.

(Image-Forming Process)

The image-forming process according to the present invention comprises forming the toner image and fixing the image by smoothing the surface of the toner image and optionally other steps.

—Forming Toner Image—

The forming of the toner image is performed by forming the toner image in the toner image-receiving sheet for the electrophotography according to the present invention.

The forming of the toner image is not restricted so long as by the forming, the toner image can be formed in the image-receiving sheet for the electrophotography and may be properly selected depending on the application. Examples of the forming of the toner image include a usual method used for the electrophotography, such as a direct transferring method in which the toner image formed on the developing roller is directly transferred to the image-receiving sheet for the electrophotography and an intermediate transferring belt method in which the toner image formed on the developing roller is primary-transferred to the intermediate transfer belt and the primary-transferred image is transferred to the image-receiving sheet for the electrophotography. Among them, from the viewpoint of environmental stability and enhancing the image quality, the intermediate transferring belt method is preferably used.

—Fixing Image by Smoothing Image Surface—

The above-noted fixing of the toner image by smoothing the surface of the toner image is smoothing the surface of the toner image formed by the above-noted toner image forming. The fixing of the toner image by smoothing the surface of the toner image comprises heating, pressing and cooling the toner image and peeling the toner image-receiving sheet using an apparatus configured to fix the toner image by smoothing the surface of the toner image which is equipped with a heating-pressing unit, a belt and a cooling unit.

The apparatus configured to fix the image by smoothing the image surface comprises a heating-pressing unit, a belt, a cooling unit, a cooling-peeling portion and optionally other units.

The heating-pressing unit is not restricted and may be properly selected depending on the application. Examples of the heating-pressing unit include a pair of heating rollers and a combination of a heating roller and a pressing roller.

The cooling unit is not restricted and may be properly selected depending on the application. Examples of the cooling unit include a cooling unit which can blow a cool air and can control the cooling temperature, and a heat sink.

The cooling-peeling portion is not restricted and may be properly selected depending on the application. Examples of the cooling-peeling portion include a section which is near of the tension roller where the image-receiving sheet for the electrophotography is peeled from the belt by own stiffness (nerve) of the image-receiving sheet.

For contacting the toner image with a heating-pressing unit of the apparatus configured to fix the image by smoothing the image surface, the image-receiving sheet is preferably pressed. The method for pressing the image-receiving sheet is not restricted and may be properly selected depending on the application; however, a nip pressure is preferably used. The nip pressure is, from the viewpoint of forming an image which is excellent in water resistance and surface smoothness and has excellent gloss, preferably 1 kgf/cm² to 100 kgf/cm², more preferably 5 kgf/cm² to 30 kgf/cm². The heating temperature in the heating-pressing unit is a temperature which is the softening point of the polymer used for producing the toner image-receiving layer, or higher and is varied depending on the type of the polymer used for producing the toner image-receiving layer; however is usually preferably 80° C. to 200° C. The cooling temperature in the cooling unit is preferably a temperature which is 80° C. at which the thermal plastic resin layer as the toner image-receiving layer is satisfactorily set, or lower, more preferably 20° C. to 80° C.

The belt comprises a heat-resistant support film and a releasing layer disposed on the support film.

The material for the support film is not restricted so long as the material has heat resistance and may be properly selected depending on the application. Examples of the material include a polyimide (PI), a polyethylene naphthalate (PEN), a polyethylene terephthalate (PET), a polyether ether ether ketone (PEEK), a polyether sulfone (PES), a poly ether imide (PEI) and a poly parabanic acid (PPA).

The releasing layer comprises preferably at least one selected from the group consisting of a silicone rubber, a fluorine rubber, a fluorocarbon siloxane rubber, a silicone resin and a fluorine resin. Among them, as the releasing layer of the belt, a releasing layer comprising a fluorocarbon siloxane rubber layer disposed on the support of the belt; and a releasing layer comprising a silicon rubber layer disposed on the support of the belt and a fluorocarbon siloxane rubber layer disposed on the silicone rubber layer are preferred.

The fluorocarbon siloxane rubber in the fluorocarbon siloxane rubber layer has preferably in the backbone chain thereof at least one of a perfluoroalkyl ether group and a perfluoroalkyl group.

The fluorocarbon siloxane rubber is preferably a cured form of a fluorocarbon siloxane rubber composition comprising the following components (A)-(D):

(A) a fluorocarbon polymer comprising mainly a fluorocarbon siloxane represented by the following formula (1) and having an unsaturated fatty hydrocarbon group, (B) at least one of organopolysiloxane and fluorocarbon siloxane which have two or more ≡SiH groups in the molecule, wherein the amount of a ≡SiH group in the above-noted siloxanes is one to four times (in terms of molar ratio) the amount of the unsaturated fatty hydrocarbon group in the above-noted fluorocarbon siloxane rubber composition, (C) a filler, and (D) an effective amount of catalyst.

The fluorocarbon polymer as the above-noted component (A) comprises mainly a fluorocarbon siloxane containing a recurring unit represented by the following formula (1) and contains an unsaturated fatty hydrocarbon group.

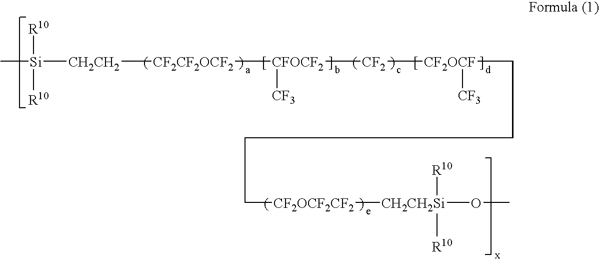

In formula (1), R¹⁰ represents an unsubstituted or substituted C₁-C₈ monovalent hydrocarbon group, preferably a C₁-C₈ alkyl group or a C₂-C₃ alkenyl group, most preferably a methyl group.

a and e are respectively an integer of 0 or 1, b and d are respectively an integer of 1 to 4 and c is an integer of 0 to 8. x is preferably an integer of 1 or more, more preferably an integer of 10 to 30.

Examples of the component (A) include a compound represented by the following formula (2):

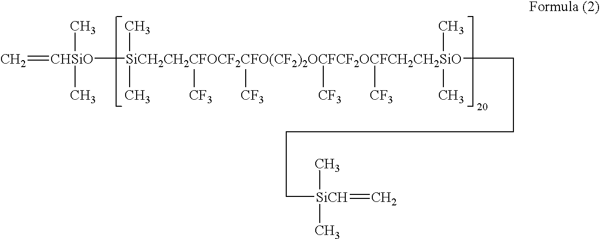

With respect to the component (B), examples of the organopolysiloxane having ≡SiH groups include an organohydrogen polysiloxane having in the molecule at least two hydrogen atoms bonded to a silicon atom.

As a curing agent curing the above-noted fluorocarbon siloxane rubber composition, when the fluorocarbon polymer as the component (A) has an unsaturated fatty hydrocarbon group, the above-noted organohydrogen polysiloxane is preferably used. In this case, the cured form is produced according to the addition reaction between the unsaturated fatty hydrocarbon group of the fluorocarbon siloxane and a hydrogen atom bonded to a silicon atom in the organohydrogen polysiloxane.

Examples of the organohydrogen polysiloxane include various organohydrogen polysiloxanes used for curing a silicone rubber composition which is cured by an addition reaction.

As the amount of the organohydrogen polysiloxane, the organohydrogen polysiloxane is incorporated in the fluorocarbon siloxane rubber composition in such a manner that the number of ≡SiH groups in the organohydrogen polysiloxane is preferably at least one, most preferably 1 to 5, relative to one unsaturated fatty hydrocarbon group in the fluorocarbon siloxane of the component (A).

Also, with respect to the component (B), preferred examples of the fluorocarbon siloxane having the ≡SiH groups include a fluorocarbon siloxane having a structure of the recurring unit represented by the formula (1), and a fluorocarbon siloxane having a structure of the recurring unit represented by the lo formula (1) in which R¹⁰ is a dialkylhydrogen siloxy group and the terminal group is a ≡SiH group, such as a dialkylhydrogen siloxy group or a silyl group. Such a preferred fluorocarbon siloxane can be represented by the following formula (3).

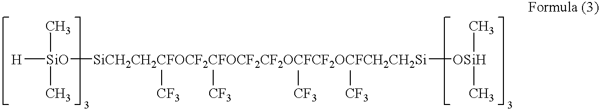

As the filler which is the component (C), various fillers used for a usual silicone rubber composition can be used. Specific examples of the filler include a reinforcing filler, such as a mist silica, a precipitated silica, a carbon powder, titanium dioxide, aluminum oxide, a quartz powder, a talc, a sericite and a bentonite; and a fiber filler, such as an asbestos, a glass fiber, and an organic fiber.

Examples of the catalyst as the component (D) include an element belonging to Group VIII in the Periodic Table and a compound thereof, such as chloroplatinic acid; alcohol-modified chloroplatinic acid; a complex of chloroplatinic acid with an olefin; platinum black and palladium which are respectively supported on a carrier, such as alumina, silica and carbon; a complex of rhodium with an olefin, chlorotris(triphenylphosphine) rhodium (Wilkinson catalyst) and rhodium (III) acetyl acetonate, which are conventional catalysts for the addition reaction. It is preferred that these complexes are used by dissolving the complex in a solvent, such as an alcohol compound, an ether compound or a hydrocarbon compound.

The fluorocarbon siloxane rubber composition is not restricted and may be properly selected depending on the application. The rubber composition may comprise various additives. Examples of the various additives include a dispersant, such as a diphenylsilane diol, a lower polymer of dimethyl polysiloxane in which the terminal of the molecule chain is blocked with a hydroxyl group, and a hexamethyl disilazane; an improving agent of heat resistance, such as ferrous oxide, ferric oxide, cerium oxide and iron octylate; and a colorant, such as a pigment.

The belt can be obtained according to a method comprising coating a heat-resistant support film with the above-noted fluorocarbon siloxane rubber composition and curing the resultant coated support film by the heating; and optionally according to a method comprising preparing a coating liquid for disposing the fluorocarbon siloxane rubber layer by diluting the fluorocarbon siloxane rubber composition with a solvent, such as m-xylene hexafluoride and benzotrifluoride; and coating the support film with the prepared coating liquid according to a general coating method, such as a spray coating, a dip coating and a knife coating. The temperature and time of the heating-curing may be properly selected from the ranges of from 100° C. to 500° C. (temperature) and from 5 seconds to 5 hours (time) depending on the type of the support film and the manufacturing method of the belt.

The thickness of the releasing layer disposed on the surface of the heat-resistant support film is not restricted and may be properly selected depending on the application; however, for obtaining an advantageous fixing properties of the image by suppressing the peeling properties of the toner or by preventing the off-set of the toner component, the thickness is preferably 1 μm to 200 μm, more preferably 5 μm to 150 μm.

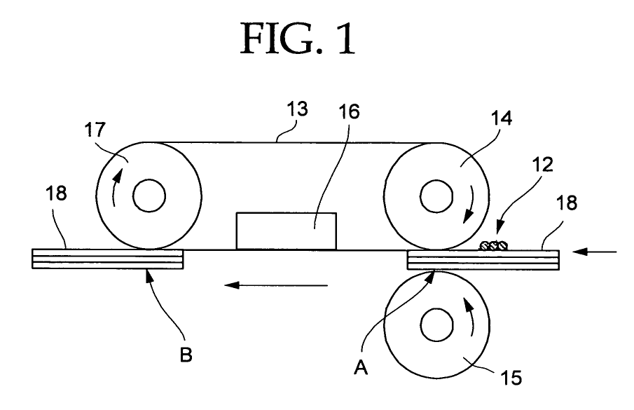

Here, with respect to an example of the image forming apparatus equipped with a typical fixing belt, explanations are given in detail with referring to FIG. 1.

First, by an image-forming apparatus (not illustrated in FIG. 1), the toner 12 is transferred to the image-receiving sheet for the electrophotography 1. The image-receiving sheet 1 to which the toner 12 is attached is conveyed to the point A by a conveying unit (not illustrated in FIG. 1) and passes through between the heating roller 14 and the pressing roller 15 to be heated and pressed at the temperature (fixing temperature) and under the pressure, wherein the temperature and pressure are enough high to soften satisfactorily the toner image-receiving layer of the image-receiving sheet 1 for the electrophotography and the toner 12.

Here, the fixing temperature means a temperature of the surface of the toner image-receiving layer measured in a nip space between the heating roller 14 and the pressing roller 15 at the point A and is preferably 80° C. to 190° C., more preferably 100° C. to 170° C. The fixing pressure means a pressure of the surface of the toner image-receiving layer measured also in a nip space between the heating roller 14 and the pressing roller 15 at the point A and is preferably 1 kgf/cm² to 10 kgf/cm², more preferably 2 kgf/cm² to 7 kgf/cm².

While the thus heated an pressed image-receiving sheet 11 is, next, conveyed by the fixing belt 13 to the cooling unit 16, in the image-receiving sheet 1, a releasing agent (not illustrated in FIG. 1) dispersed in the toner image-receiving layer is satisfactorily heated and molten. The molten releasing agent is gathered to the surface of the toner image-receiving layer, so that in the surface of the toner image-receiving layer, a layer (film) of the releasing agent is formed. The image-receiving sheet 1 conveyed to the cooling unit 16 is cooled by the cooling unit 16 to a temperature which is, for example, not higher than either the softening point of a binder resin used for producing the toner image-receiving layer or the toner, or the temperature which is higher than the glass transition point of the above-noted binder resin by 10° C., wherein the temperature to which the image-receiving sheet 1 is cooled is preferably 20° C. to 80° C., more preferably room temperature (25° C.). Thus, the layer (film) of the releasing agent formed in the surface of the toner image-receiving layer is cooled and set, thereby forming the releasing layer.

The cooled image-receiving sheet 1 is conveyed by the fixing belt 13 further to the point B and the fixing belt 13 moves along the tension roller 17. Accordingly, at the point B, the image-receiving sheet 1 is peeled from the fixing belt 13. It is preferred that the diameter of the tension roller 17 is specified to be so small that the image-receiving sheet 1 can be peeled from the fixing belt 13 by own stiffness (nerve) of the image-receiving sheet 1.

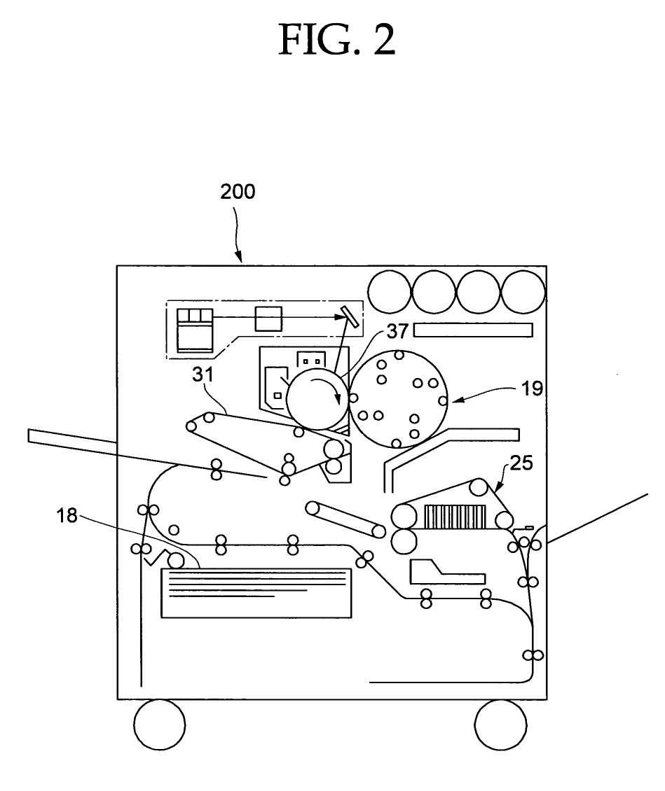

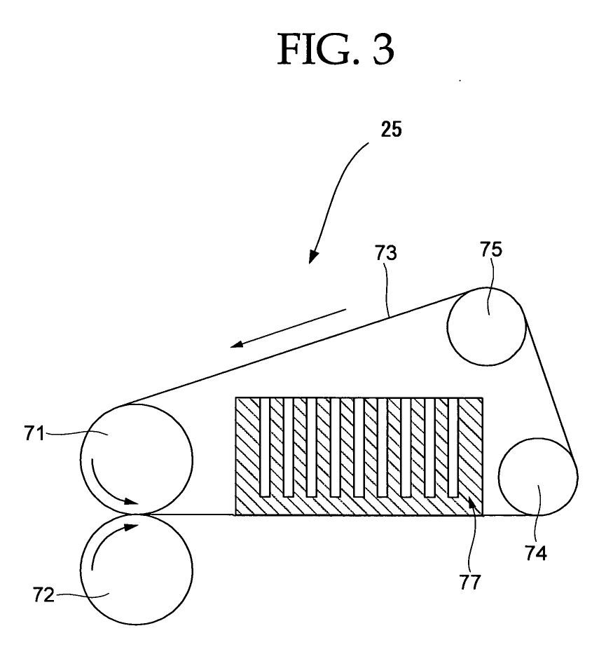

An apparatus configured to fix the image by smoothing the image surface shown in FIG. 3 can be used in an image-forming apparatus (e.g., a full-color laser printer DCC-500 (manufactured and sold by Fuji Xerox Co., Ltd.)) shown in FIG. 2 by converting the image-forming apparatus to the belt fixing part in the image-forming apparatus.

As shown in FIG. 2, the image-forming apparatus 200 includes photoconductive drum 37, developing unit 19, intermediate transferring belt 31, the image-receiving sheet for the electrophotography 18, and fixing part 25 (the apparatus configured to fix the image by smoothing the image surface).

FIG. 3 shows the fixing part 25 (the apparatus configured to fix the image by smoothing the image surface) which is arranged as the belt fixing part of the image-forming apparatus 200 shown in FIG. 2.

As shown in FIG. 3, the apparatus configured to fix the image by smoothing the image surface 25 comprises heat roller 71, peeling roller 74, tension roller 75, endless belt 73 supported rotatably by the tension roller 75 and pressure roller 72 press-contacted to the heat roller 71 through the endless belt 73.

Cooling heatsink 77 which forces the endless belt 73 to cool is arranged inside the endless belt 73 between the heat roller 71 and the peeling roller 74. The cooling heatsink 77 constitutes the cooling and sheet-conveying unit for cooling and conveying the image-receiving sheet for the electrophotography 18.

In the apparatus configured to fix the image by smoothing the image surface 25 as shown in FIG. 3, the image-receiving sheet for the electrophotography bearing a color toner image transferred and fixed on the surface of the image-receiving sheet, is introduced into a press-contacting portion (or nip portion) between the heat roll 71 and the pressure roll 72 press-contacted to the heat roller 71 through the endless belt 73 in such as manner that the color toner image in the image-receiving sheet faces to the heat roller 71, wherein while the image-receiving sheet passes through the press-contacting portion between the heat roller 71 and the pressure roller 72, the color toner image is heated and molten to be fixed on the image-receiving sheet for the electrophotography.

Thereafter, the image-receiving sheet for the electrophotography bearing the color toner image fixed in the image-receiving layer of the image-receiving sheet by heating the toner of the color toner image to a temperature of substantially from 120 to 130° C. at the press-contacting portion between the heat roller 71 and the pressure roller 72 is conveyed by the endless belt 73 in such a manner that the toner image-receiving layer in the surface of the image-receiving label sheet is adhered to the surface of the endless belt 73. During the conveying of the image-receiving sheet, the endless belt 73 is forced to be cooled by the cooling heatsink 77 and the color toner image and the image-receiving layer are cooled and set, so that the image-receiving sheet for the electrophotography is peeled from the endless belt 73 by the peeling roller 74 and own stiffness (nerve) of the image-receiving sheet.

The surface of the endless belt 73 after the peeling of the image-receiving sheet is cleaned by removing a residual toner therefrom using a cleaner (not illustrated in FIG. 3) and prepared for the next fixing of the image by smoothing the image surface.

According to the image-forming process according to the present invention, even if by using an image-forming apparatus equipped with no fixing oil, not only the peeling properties of the image-receiving sheet for the electrophotography and the toner can be suppressed or the off-set of the image-receiving sheet for the electrophotography and the toner components can be prevented, so that a stable feeding of the image-receiving sheet can be obtained, but also by the image-receiving sheet for the electrophotography having stable conveyability which does not cause a convey failure, such as jamming and multiple feeding, an image having a similar high image-quality to a print of a silver salt photography can be formed.

Hereinbelow, with referring to Examples and Comparative Examples, the present invention is explained in detail and the following Examples and Comparative Examples should not be construed as limiting the scope of the present invention.

—Preparing of Raw Paper—

A pulp slurry was prepared by beating LBKP (broad-leaf kraft pulp, bleaching pulp) to 300 ml of Canadian Standard Freeness using a disk refiner so that the pulp fiber has a weight average fiber length of 0.60 mm. The prepared pulp slurry was mixed with the additives shown in the following table and in the following amount, thereby preparing a paper material for producing the raw paper.

| Type of Additives | Amount (%) |
|---|---|
| Cationic Starch | 1.2 |
| Alkyl Ketene Dimer (AKD) | 0.5 |
| Anionic Polyacrylamide | 0.3 |
| Epoxidized Fatty acid Amide (EFA) | 0.2 |
| Polyamidepolyamineepichlorohydrin | 0.3 |

wherein AKD comprises an alkyl moiety of a fatty acid (mainly behenic acid) derivative, EFA comprises a fatty acid moiety of a fatty acid (mainly behenic acid) derivative, and the amount (%) is relative to 100% of the mass of the pulp.

The prepared paper material was subjected to the papermaking using a Fourdrinier papermaking machine to produce a raw paper having a basis weight of 150 g/m². During the drying in the papermaking by the Fourdrinier papermaking machine, the both surfaces of the obtained raw paper was coated respectively with a polyvinyl alcohol (PVA) in an amount of 1.0 g/m² and with CaCl₂ in an amount of 0.8 g/m² using a size press apparatus to dry the obtained raw paper.

At the end of the papermaking, the dried raw paper was subjected to a calendar treatment using a soft calendar apparatus, thereby controlling the density of the raw paper to 1.01 g/cm³. Also, during the drying, a surface of the raw paper on which a toner image-receiving layer will be disposed was pressed to the metal roll having a surface temperature of 140° C. The obtained raw paper had a whiteness degree of 91%, an Oken type smoothness (TAPPI smoothness) of 265 sec and a sizing/Stockigt method of 127 sec.

The obtained raw paper was subjected to the corona discharge having an output of 17 kW and on the back surface of the obtained raw paper, a polyethylene resin having a composition (70% by mass of HDPE and 30% by mass of LDPE) shown in Table 3 (as the content (% by mass)) was laminated by single-layer extrusion using a cooling roll having a surface matt roughness of 10 μm at a molten delivered film temperature of 320° C. and a line speed of 250 m/min, thereby disposing a back surface polyethylene layer having a thickness of 22 μm.

TABLE 2

| | MFR (g/10 min) | Density (g/cm³) | Content (% by mass) |
|---|---|---|---|
| HDPE | 12 | 0.967 | 70 |
| LDPE | 3.5 | 0.923 | 30 |

wherein HDPE means a high density polyethylene and LDPE means a low density polyethylene. MFR and Density are properties of HDPE and LDPE and Content is the composition of the above-noted polyethylene resin.

Next, on the surface of the raw paper (on which the toner image-receiving layer will be disposed), a mixture of an LDPE masterbatch pellet having a s composition shown in Table 3 and an LDPE masterbatch pellet comprising a 5% by mass ultramarine blue, wherein the mixture has a composition shown in Table 4, was laminated by single-layer extrusion using a cooling roll having a surface matt roughness of 0.7 μm at a line speed of 250 m/min, thereby disposing a surface polyethylene layer having a thickness of 29 μm.

Thereafter, the surface and the back surface of the raw paper were subjected to the corona discharge having an out put of respectively 18 kW and 12 kW and on the surface of the raw paper, a gelatin undercoating layer was disposed, thereby obtaining a support.

TABLE 3

| Composition | Content (% by mass) |
|---|---|
| LDPE(ρ = 0.921 g/cm³) | 37.98 |
| Titanium dioxide in form of anatase | 60.00 |
| Zinc stearate | 2.00 |
| Antioxidant | 0.02 |

TABLE 4

| Composition | Content (% by mass) |
|---|---|
| LDPE(ρ = 0.921 g/cm³) | 67.7 |
| Titanium dioxide in form of anatase | 30.0 |
| Zinc stearate | 2.0 |
| Ultramarine blue | 0.3 |

### EXAMPLES 1 TO 12 AND COMPARATIVE EXAMPLES 1 TO 2

—Production of Image-Receiving Sheet for Electrophotography—

The above-obtained support was coated with a coating liquid for disposing the toner image-receiving layer having the following composition using a wire coater under the conditions of at 90° C. and for 2 minutes, thereby disposing the toner image-receiving layer having a thickness shown in Table 5. As noted above, the toner image-receiving sheets for the electrophotography of Examples 1 to 12 and Comparative Examples 1 to 2.

—Preparing of Titanium Dioxide Dispersion—

The following components were mixed to disperse titanium dioxide using a dispersing machine (manufactured and sold by Nihon Seiki Seisakusho Co., Ltd.; trade name: NBK-2), thereby preparing a titanium dioxide dispersion (40% by mass of titanium dioxide pigment),

40.0 g of titanium dioxide (manufactured and sold by Ishihara Sangyo Kaisha, Ltd.; trade name: TIPAQUE R780-2),

2.0 g of a polyvinyl alcohol (manufactured and sold by Kuraray Co., Ltd.; trade name: PVA 102),

58.0 g of an ion-exchanged water.

—Coating Liquid for Toner Image-Receiving Layer—

A coating liquid for disposing the toner image-receiving layer was prepared by mixing the following components:

15.5 g of the above-prepared titanium dioxide dispersion,

135 g of the mixture of an aqueous polymer dispersion (A-1 to A-3 shown in Table 5) and a water-dispersible rosin derivative (B-i to B-3 shown in Table 5),

15.0 g of a carnauba wax dispersion (manufactured and sold by Chukyo Yushi Co., Ltd.; trade name: Cellosol 524),

2.0 g of a thickening agent (manufactured and sold by Meisei Chemical Works, Ltd.; trade name: ALKOX E 30), and

80 ml of ion-exchanged water.

TABLE 5

| | Aqueous Polymer Dispersion | | | Water-dsipersible Rosin Derivative | | | |
|---|---|---|---|---|---|---|---|
| | (Parts by mass) | | | (Parts by mass) | | | Thickness of toner image- |
| | A-1 | A-2 | A-3 | B-1 | B-2 | B-3 | receiving layer (μm) |
| Example 1 | — | 90 | — | 10 | — | — | 10 |
| Example 2 | — | 90 | — | — | 10 | — | 10 |
| Example 3 | — | 85 | — | 15 | — | — | 10 |
| Example 4 | — | 90 | — | — | — | 10 | 10 |
| Example 5 | 90 | — | — | 10 | — | — | 10 |
| Example 6 | — | — | 90 | 10 | — | — | 10 |
| Example 7 | — | 75 | — | 25 | — | — | 10 |
| Example 8 | — | 65 | — | 35 | — | — | 10 |
| Example 9 | — | 75 | — | — | 25 | — | 10 |
| Example 10 | — | 75 | — | — | — | 25 | 10 |
| Example 11 | 75 | — | — | 25 | — | — | 10 |
| Example 12 | — | — | 75 | 25 | — | — | 10 |
| Comp. Ex. 1 | — | 100 | — | — | — | — | 10 |
| Comp. Ex. 2 | — | — | — | 100 | — | — | 10 |

wherein the amount of Aqueous Polymer Dispersion (Parts by mass) is indicated in terms of the solid mass.

A-1 to A-3 and B-1 to B-3 in Table 5 represent respectively the following components:

A-1: An acrylic emulsion (trade name: Johncryl 7610; manufactured and sold by Johnson Polymer Corporation; having a number average molecular weight (Mn) of 330,000, a glass transition temperature of 22° C. and an average particle diameter of 0.08 μm),

A-2: An acrylic emulsion (trade name: PDX 7325; manufactured and sold by Johnson Polymer Corporation; having a number average molecular weight (Mn) of 300,000, a glass transition temperature of 66° C. and an average particle diameter of 0.1 μm),

A-3: An acrylic emulsion (trade name: Johncryl 7610; manufactured and sold by Johnson Polymer Corporation; having a number average molecular weight (Mn) of 300,000, a glass transition temperature of 96° C. and an average particle diameter of 0.08 μm),

B-1: A water-dispersible rosin derivative (trade name: Super Ester E-720; manufactured and sold by Arakawa Chemical Industries, Ltd.; having a softening point of 100° C.),

B-2: A water-dispersible rosin derivative (trade name: Super Ester E-625; manufactured and sold by Arakawa Chemical Industries, Ltd.; having a softening point of 125° C.), and

B-3: A water-dispersible rosin derivative (trade name: Super Ester E-650; manufactured and sold by Arakawa Chemical Industries, Ltd.; having a softening point of 160° C.).

Next, with respect to the obtained toner image-receiving sheets for the electrophtography of Examples 1 to 12 and Comparative Examples 1 to 2 respectively, adhesion resistance, crazing, image quality (glossiness) were respectively evaluated according to the following method. The result of the evaluation is shown in Table 6.

—Evaluation of Adhesion Resistance—

After the sample of each produced toner image-receiving sheet for the electrophtography in Examples 1 to 12 and Comparative Examples 1 to 2 was subjected to the specified atmosphere (40° C.-80% RH) for 24 hours, the sample for evaluation of the adhesion resistance was prepared in such a manner that two toner image-receiving sheets having a size of A4 are superimposed by contacting the toner image-receiving layer of a sheet with that of another sheet, thereby obtaining the sample comprising two sheets. The obtained sample was subject to the pressing by a weight of 500 g which has a cross section size of 3.5 cm'3.5 cm 5 and was left in the above-noted atmosphere for 7 days. With respect to the resultant sample, the adhesion resistance of the sheet was evaluated by observation of peeling a sheet from another sheet in the sample according to the following criteria. According to the present invention, the adhesion resistances represented by the following criteria A and B are practically qualified.

[Evaluation Criteria]

A there was no peeling sound and no adhesion trace.

B there was a light peeling sound and a light adhesion trace.

C there was remained less than 25% of an adhesion trace.

D there was remained 25% to 50% of an adhesion trace.

E there was remained 50% or more of an adhesion trace.

<Evaluation of Resistance to Crazing>

Using a color laser printer (manufactured and sold by Fuji Xerox Co., Ltd.;

trade name: C-2220), an image having a size of 10 cm×10 cm in maximum density of black was formed in the sample of each produced toner image-receiving sheet for the electrophtography in Examples 1 to 12 and Comparative Examples 1 to 2 and the sample was left in the atmosphere of 10° C. and 15% RH for 1 day. Bars having respectively the diameter of 1, 2, 3, 4 and 5 cm were prepared. The sample was wound around the above-prepared bars in such a manner that the image-receiving layer of the sample faces outwards and it is observed whether the crazing was caused or not in the sample and the minimum diameter of the bar around which a sample having no crazing was wound, was noted.

<Evaluation of Image Quality (Glossiness)>

In the sample of each produced toner image-receiving sheet for the electrophtography in Examples 1 to 12 and Comparative Examples 1 to 2, the image was formed using the apparatus for the electrophotography comprising the fixing belt and the glossiness of the image was evaluated according to the following method. In the sample of the image-receiving sheet, an image having a size of 10 cm×10 cm in 6 densities of black, such as 0, 20, 40, 60, 80 and 100% was formed. The glossiness of the images in 6 densities were respectively measured according to JIS Z 8741 using a digital angle-variable gloss meter (manufactured and sold by Suga Test Instrument Co., Ltd.; trade name: UGV-5D) under the condition where the acceptance angle is 20° and the minimum value of the glossiness was noted.

More specifically, as the image for the printing, four images, such as a white solid image, an image of gray (all of R value, G value and B value of the image are 50%), a black solid image and an image of a woman's portrait were printed (formed) on the sample using an apparatus for the electrophotography.

The used apparatus for the electrophotography is an apparatus which was converted from the color laser printer (manufactured and sold by Fuji Xerox Co., Ltd.; trade name: C-2220) by attaching the following fixing belt thereto.

The fixing belt was prepared as follows. A belt support made of polyimide resin was coated with a silicone rubber primer (manufactured and sold by Dow Corning Toray Silicone Co., Ltd.; trade name: DY39-115), followed by wind-drying the resultant coating for 30 minutes and another coating was formed on the above-formed coating according to a dip coating using a coating liquid comprising 100 parts by mass of a silicone rubber precursor (manufactured and sold by Dow Corning Toray Silicone Co., Ltd.; trade name: DY35-796AB) and 30 parts by mass of n-hexane, followed by primary-vulcanizing the resultant coating at 120° C. for 10 minutes, thereby forming a silicone rubber layer having a thickness of 40 μm.

On the thus formed silicone rubber layer, a coating film was formed according to a dip coating using a coating liquid comprising 100 parts by mass of a fluorocarbon siloxane rubber precursor (manufactured and sold by Shin-Etsu Chemical Co., Ltd.; tarde name: SIFEL610) and 20 parts by mass of a solvent containing a fluorine atom (solvent mixture of m-xylene hexafluoride, perfluoroalkane and perfluoro (2-butyl tetrahydrofuran)), followed by primary-vulcanizing the resultant coating at 120° C. for 10 minutes and secondary-vulcanizing the coating at 180° C. for 4 hours, thereby preparing a fixing belt comprising the fluorocarboncyclohexane rubber layer having a thickness of 20 μm.

For the evaluation, the printing was performed under the conditions of the printing speed of 30 mm/ sec (in principle) and the fixing temperature of the toner, such as the temperature of the heating roller of 155° C. and the temperature of the pressing roller of 130° C. Using the above-noted apparatus for the electrophotography, the patterns of the above-noted four images, such as the image of a woman's portrait, white solid image, gray image and black solid image which have a size of 5 cm×5 cm were transferred to the sample of the image-receiving sheet for the electrophotography.

TABLE 6

| | Result of Evaluation | | |
|---|---|---|---|
| | Adhesion | Resistance to | Image Quality |
| | Resistance | Crazing (cm) | (glossiness) |
| Example 1 | B | 1 | 85 |
| Example 2 | B | 1 | 86 |
| Example 3 | B | 3 | 88 |
| Example 4 | B | 1 | 75 |
| Example 5 | C | 1 | 70 |
| Example 6 | A | 2 | 72 |
| Example 7 | B | 3 | 86 |
| Example 8 | C | 3 | 88 |
| Example 9 | B | 4 | 84 |
| Example 10 | B | 3 | 82 |
| Example 11 | C | 2 | 84 |
| Example 12 | B | 2 | 74 |
| Comp. Ex. 1 | B | 1 | 30 |
| Comp. Ex. 2 | C | 5 | 90 |

From the result of the evaluation shown in Table 6, it is confirmed that the image-receiving sheets produced in Examples 1 to 12 which comprise a toner image-receiving layer comprising a mixture of an aqueous polymer dispersion having a glass transition temperature (Tg) of 30° C. to 90° C. and a number average molecular weight of 30,000 to 500,000, and a water-dispersible rosin derivative having a softening point of 50° C. to 150° C. are more excellent in adhesion resistance and resistance to crazing, and can obtain an image having a higher image quality in comparison with the image-receiving sheets produced in Comparative Examples 1 to 2.

The image-receiving sheet for the electrophotography according to the present invention are excellent in adhesion resistance and resistance to crazing, can obtain an image having a high image quality and can be applied preferably to an image forming apparatus with high speed fixing.

According to the image forming process according to the present invention, even when an image-forming apparatus equipped with no fixing oil is used, not only the peeling properties of the image-receiving sheet for the electrophotography and the toner, and the offset of the image-receiving sheet for the electrophotography and the components of the toner can be prevented; and a stable paper feeding can be obtained, but also the image-receiving sheet for the electrophotography is excellent in adhesion resistance and resistance to crazing and can form an image having a high image quality compared to that of a silver salt photography print.

1. An image-receiving sheet for the electrophotography comprising:
a support, and
a toner image-receiving layer disposed on the support,
wherein the toner image-receiving layer comprises a mixture of an aqueous polymer dispersion and water-dispersible rosins.

2. The image-receiving sheet for the electrophotography according to claim 1, wherein a polymer in the aqueous polymer dispersion has a glass transition temperature (Tg) of 30° C. to 90° C. and a number average molecular weight (Mn) of 30,000 to 500,000.

3. The image-receiving sheet for the electrophotography according to claim 1, wherein the aqueous polymer dispersion comprises an acrylic emulsion.

4. The image-receiving sheet for the electrophotography according to claim 1, wherein the water-dispersible rosins have a softening point of 50° C. to 150° C.

5. The image-receiving sheet for the electrophotography according to claim 1, wherein the water-dispersible rosins comprise at least one selected from the group consisting of a water-dispersible rosin, a water-dispersible rosin derivative and salts thereof.

6. The image-receiving sheet for the electrophotography according to claim 1, wherein a mixing mass ratio of the water-dispersible rosins in the mixture is 20% by mass or less, based on the mass of the solid in the mixture.

7. The image-receiving sheet for the electrophotography according to claim 1, wherein the amount of the mixture in the toner image-receiving layer is 50% by mass or more.

8. The image-receiving sheet for the electrophotography according to claim 1, wherein the support is one selected from the group consisting of raw paper, a synthetic paper, a synthetic resin sheet, a coated paper and a laminated paper.

9. The image-receiving sheet for the electrophotography according to claim 1, wherein the support comprises raw paper and polyolefin resin layers disposed on the both surfaces of raw paper.

10. The image-forming process comprising:
forming a toner image in an image-receiving sheet for the electrophotography, and
fixing the toner image by smoothing a surface of the toner image formed in forming the toner image,
wherein the image-receiving sheet for the electrophtography comprises a support and a toner image-receiving layer comprising a mixture of an aqueous polymer dispersion and water-dispersible rosins.

11. The image-forming process according to claim 10, wherein the fixing of the image by smoothing the surface of the toner image comprises the heating, pressing, cooling and peeling of the toner image using an apparatus configured to fix the image by smoothing the surface of the toner image which is equipped with a heating-pressing unit, a belt and a cooling unit.

12. The image-forming process according to claim 11, wherein the belt comprises a fluorocarbon siloxane rubber layer disposed in the surface of the belt.

13. The image-forming process according to claim 12, wherein a fluorocarbon siloxane rubber in the fluorocarbon siloxane rubber layer has in the backbone chain thereof at least one of a perfluoroalkyl ether group and a perfluoroalkyl group.

14. The image-forming process according to claim 11, wherein the belt comprises a silicone rubber layer disposed in the surface of the belt and a fluorocarbon siloxane rubber layer disposed on the silicone rubber layer.

15. The image-forming process according to claim 14, wherein a fluorocarbon siloxane rubber in the fluorocarbon siloxane rubber layer has in the backbone chain thereof at least one of a perfluoroalkyl ether group and a perfluoroalkyl group.
